(19) United States
(12) Patent Application Publication
(10) Pub. No.: US 2026/0289174 A1
(43) Pub. Date: Sep. 24, 2026

(54) SYSTEM

(71) Applicant: SoftBank Group Corp., Tokyo (JP)

(72) Inventor: Noriaki KODAIRA, Tokyo (JP)

(73) Assignee: SoftBank Group Corp., Tokyo (JP)

(21) Appl. No.: 19/564,511

(22) Filed: Mar. 12, 2026

(30) Foreign Application Priority Data
Mar. 19, 2025 (JP) 2025-044943

(51) Int. Cl. G06F 40/40; G06F 40/284; G06F 40/295; G10L 25/63; H04W 4/12

(52) U.S. Cl. CPC G06F 40/40; G06F 40/284; G06F 40/295; G10L 25/63; H04W 4/12

(57) ABSTRACT

A system includes a processor that is configured to convert voice data into text data, generate a prompt for instructing a generative AI model to evaluate a possibility of fraudulent activity, input the prompt into the generative AI model, and execute a predetermined action based on an evaluation result output by the generative AI model.

### CROSS-REFERENCE TO RELATED APPLICATION

This application is based on and claims priority under 35 USC 119 from Japanese Patent Application No. 2025-044943 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional techniques for detecting fraudulent activity in communication, such as rule-based filters or static machine learning models, are often limited in their ability to flexibly understand natural language and to adapt to new or rapidly evolving fraud patterns. In many cases, existing systems cannot accurately analyze free-form conversational voice data in real time, and therefore fail to identify subtle or newly emerging fraudulent behaviors. Furthermore, known systems frequently apply simple keyword matching or fixed pattern recognition to text data, which leads to high false positive rates, missed detections, and insufficient support for timely protective actions on behalf of users. As a result, users, including vulnerable users such as elderly individuals, remain exposed to a significant risk of financial and other harm from fraudulent activity conducted via telephone calls, voice messages, and other communication channels. Accordingly, there is a need for a system that can convert voice data into text data, leverage a generative AI model to evaluate a possibility of fraudulent activity with high flexibility and contextual understanding, and automatically execute predetermined protective actions in real time based on an evaluation result.

### SUMMARY

In order to solve the above-described problems, a system is provided that comprises a processor, wherein the processor is configured to convert voice data into text data, generate a prompt for instructing a generative AI model to evaluate a possibility of fraudulent activity, input the prompt into the generative AI model, and execute a predetermined action based on an evaluation result output by the generative AI model. The processor is further configured to use a pattern recognition technique or a machine learning algorithm when generating the prompt for instructing the generative AI model to evaluate the possibility of fraudulent activity, thereby enabling the prompt to reflect characteristic patterns associated with known or suspected fraudulent behavior. By using the generative AI model in this manner, the processor is configured to protect a user from fraudulent activity in real time, for example by triggering recording of suspicious communications, issuing alerts to predetermined contacts, or activating other predetermined countermeasures based on the evaluation result. Through these configurations, the system achieves improved detection accuracy and responsiveness against fraudulent activity compared to conventional techniques.
The term “voice data” refers to audio data representing spoken utterances of a user or another party, including but not limited to live telephone conversations, recorded voice messages, or any other acoustic signals that contain human speech to be processed by the system.
The term “text data” refers to character-based or symbol-based data obtained by converting voice data or other audio content into a written or machine-readable textual representation, suitable for natural language processing, pattern recognition, or further analysis by a generative AI model.
The term “generative AI model” refers to an artificial intelligence model capable of generating or transforming content, such as text, based on an input prompt, and configured in the present invention to analyze or evaluate a possibility of fraudulent activity from textual or other contextual information.
The term “prompt” refers to a structured input, including textual instructions, contextual information, or data representations, that is provided to the generative AI model in order to cause the generative AI model to perform a specific task, such as evaluating a possibility of fraudulent activity.
The term “fraudulent activity” refers to an act or attempted act intended to deceive, mislead, or unlawfully obtain money, property, or sensitive information from a user, including but not limited to special fraud, phishing, impersonation scams, or other unlawful schemes conducted through communication channels.
The term “pattern recognition technique” refers to a computational method or algorithm that identifies patterns, regularities, or characteristic features in data, such as recurring phrases, semantic structures, or behavioral signatures, which are associated with fraudulent activity or normal communication.
The term “machine learning algorithm” refers to an algorithm or model that learns from examples or historical data to classify, predict, or evaluate outcomes, and that is used in the present invention to assist in generating prompts or assessing characteristics related to a possibility of fraudulent activity.
The term “evaluation result” refers to an output produced by the generative AI model that indicates a result of evaluating a possibility of fraudulent activity, including but not limited to a score, probability, classification label, risk level, or descriptive explanation relevant to determining whether fraudulent activity is likely.
The term “predetermined action” refers to an operation or set of operations that is specified in advance and that is automatically executed by the system based on the evaluation result, such as recording communication data, issuing an alert to a user or a third party, restricting certain functions, or logging information for further review.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

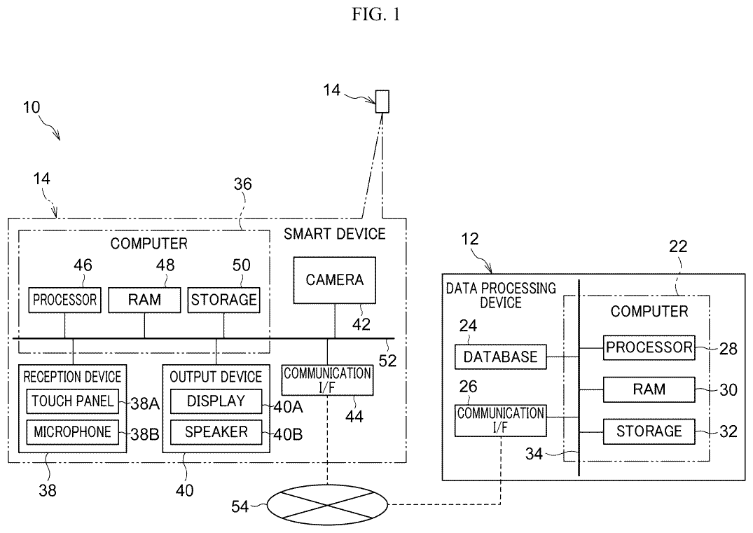

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

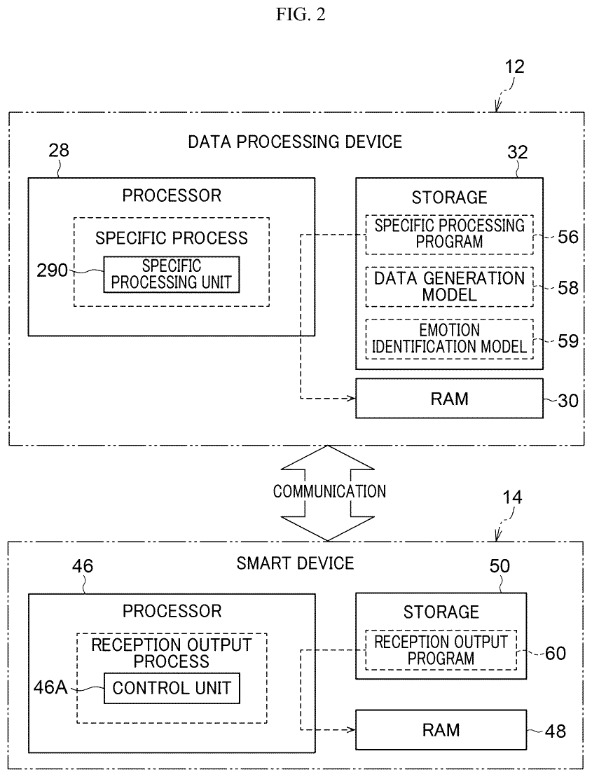

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented fraud detection techniques for communications such as voice calls and messages typically rely on static rule sets, simple keyword matching, or offline analysis that occurs after completion of a communication session. These conventional techniques suffer from multiple technical limitations. First, they lack a robust mechanism to transform streaming audio data into structured textual data together with contextual communication metadata in a form that is optimized for downstream machine-learning analysis. As a result, important contextual signals, such as communication time, direction, and caller identity, are either lost or not consistently included in the analysis, which reduces detection accuracy.
Second, even when a generative AI model or other machine-learning model is available, conventional systems do not systematically generate prompt sentences that are tailored to the specific communication content, the definition of fraudulent activity, and the desired structured output format. In many implementations, the model is invoked with ad hoc or manually crafted prompts that do not constrain the output format or explicitly specify evaluation criteria. This leads to non-deterministic or unstructured model responses that are difficult for the computer system to parse and to map to actionable risk scores in real time. Consequently, the system cannot reliably compare model outputs against numerical thresholds or policy rules, and fails to automatically trigger appropriate protective actions during an ongoing communication.
Third, conventional architectures are not optimized for real-time, iterative evaluation of streaming communication content. Existing systems often process entire call recordings or message logs in batch mode after the communication has ended, which introduces latency and makes it impossible to warn the user or initiate protective operations while the fraudulent interaction is actually occurring. This results in a technical deficiency in the end-to-end processing pipeline: the processor does not continuously update a machine-interpretable risk index in synchrony with the progression of the communication and cannot deterministically issue control signals when a threshold is exceeded.
Fourth, conventional systems lack an integrated control mechanism that links the structured output of a generative AI model to concrete device-level operations such as recording, data storage, user interface alerts, and external notifications. In many implementations, human intervention is required to interpret the model's free-form explanation and decide whether to save logs, show warnings, or notify third parties. This human-in-the-loop approach introduces delay and variability, preventing the computer system from autonomously enforcing consistent, policy-driven responses.

Accordingly, there is a need for an improved computer-implemented system that (i) acquires and preprocesses communication data, including audio and text, together with relevant metadata in a structured form, (ii) automatically generates prompt sentences that guide a generative AI model to output a structured risk index and explanation according to predefined criteria, (iii) repeatedly evaluates streaming communication content in real time to maintain an updated numerical risk index, and (iv) deterministically converts threshold crossings of the risk index into control signals that trigger predefined protective operations on a terminal or external device without human intervention. Such a system would improve the technical functioning of the fraud detection pipeline on a computer by enabling more accurate, timely, and machine-actionable assessments of fraudulent activity in ongoing communications.

The specific processing by the specific processing unit 290 of the data processing device 12 in Example 1 is realized by the following means.

The present invention provides a server comprising a processor configured to receive, via a secure communication path from a terminal, preprocessed character information and additional information including communication time information and caller identification information corresponding to communications of a user; generate, based on the preprocessed character information and the additional information, a prompt sentence that instructs evaluation of a possibility of fraudulent activity, embeds the character information and definition information of the fraudulent activity into the prompt sentence, and specifies an output format and evaluation criteria for a generative AI model; input the prompt sentence into the generative AI model and obtain an evaluation result including a numerical risk index and explanation information; determine a risk level of the fraudulent activity by comparing the numerical risk index with a predetermined threshold; and output, when the risk level satisfies a predetermined condition, a control signal to cause execution of at least one predefined operation including storing a call record or a communication record in a storage device, displaying warning information on the terminal, and transmitting notification information to a pre-registered contact, while storing the evaluation result and the control signal in association with each other in a recording device. This enables the computer-implemented fraud detection system to transform heterogeneous communication data into structured inputs for the generative AI model, obtain structured and machine-parsable risk assessments in real time, and autonomously trigger device-level protective operations based on deterministic threshold comparisons of the numerical risk index, thereby improving the technical performance, reliability, and responsiveness of fraud detection in ongoing communications.
The term “system” refers to a combination of one or more computing devices, communication devices, and storage devices that cooperate via hardware and software to perform the processes described in the claims.
The term “processor” refers to a hardware processing unit or a collection of hardware processing units, such as a central processing unit or a microcontroller, that executes instructions stored in a memory to implement the claimed functions.
The term “terminal” refers to an electronic device operated by a user, such as a portable information device, a smartphone, or a communication terminal, that performs monitoring of communications and exchanges data with a server.
The term “server” refers to a computing apparatus, which may include one or more processors and storage devices, that provides processing services to one or more terminals over a communication network.
The term “communication” refers to an exchange of information between at least two parties, including but not limited to voice calls, text messages, and other digital message transmissions.
The term “user” refers to a human operator of the terminal who participates in communications and is a subject of fraud protection by the system.
The term “audio information” refers to data representing sound, including spoken voice in a communication, in the form of analog signals or digital audio signals.
The term “character information” refers to data representing text, including textual content converted from audio information or obtained directly from messages, in a machine-readable character format.
The term “preprocessing” refers to a sequence of data processing operations applied to acquired information, including conversion, formatting, association with metadata, and preparation of the information for input to a generative AI model.
The term “additional information” refers to metadata associated with character information, including but not limited to communication time information, caller identification information, message identifiers, and session identifiers.
The term “communication time information” refers to temporal data indicating when a communication occurred or is occurring, including timestamps, start times, end times, and duration information.
The term “caller identification information” refers to data that identifies a communication party, including but not limited to phone numbers, user identifiers, and communication account identifiers.
The term “prompt sentence” refers to a natural language or structured text input provided to a generative AI model, which instructs the model regarding a task to be performed, such as evaluating a possibility of fraudulent activity, and specifies constraints such as output format and evaluation criteria.
The term “generative AI model” refers to a machine-learning model, typically a neural network such as a language model, that generates outputs including text or structured data in response to input prompts, and that is capable of evaluating communication content with respect to fraudulent activity.
The term “definition information of the fraudulent activity” refers to information that specifies what constitutes fraudulent activity for the purposes of the system, including examples, patterns, and criteria used by the generative AI model to perform evaluation.
The term “output format” refers to a predetermined structure of data expected as output from the generative AI model, including defined fields such as a numerical risk index and explanation information, which are machine-parsable by the processor.
The term “evaluation criteria” refers to one or more rules, thresholds, or qualitative standards specified in a prompt sentence or configuration data, which guide the generative AI model in assessing the possibility or severity of fraudulent activity.
The term “evaluation result” refers to the output produced by the generative AI model in response to a prompt sentence, including at least a numerical risk index and optionally explanation information or classification labels.
The term “numerical risk index” refers to a quantitative value, such as a real number within a specified range, that represents the likelihood or severity of fraudulent activity as determined by the generative AI model or post-processing logic.
The term “risk level” refers to a classification of the possibility of fraudulent activity, determined by comparing the numerical risk index to one or more predetermined thresholds.
The term “predetermined threshold” refers to a reference value stored in a memory, against which the numerical risk index is compared to determine whether a particular risk level or control action condition is satisfied.
The term “predetermined condition” refers to a logical condition defined in advance, such as the numerical risk index being greater than or equal to a predetermined threshold, that triggers execution of specific control actions.
The term “control signal” refers to a data signal or command generated by the processor to instruct a terminal or an external device to perform one or more predefined operations.
The term “call record” refers to stored data relating to a voice communication, including at least a recording of the audio information and optionally associated metadata such as timestamps and participant identifiers.
The term “communication record” refers to stored data relating to a communication other than or including a voice call, such as a text message history or chat log, together with associated metadata.
The term “storage device” refers to a hardware device capable of storing digital data, such as a memory device, a magnetic disk device, or a solid-state drive, used to retain call records, communication records, and evaluation results.
The term “recording device” refers to a storage subsystem or data management component that stores and manages evaluation results, control signals, and related historical information in an organized manner for later retrieval.
The term “warning information” refers to data presented to a user on a terminal, such as a message, indicator, or alert, that notifies the user of a detected or suspected fraudulent activity.
The term “notification information” refers to data transmitted to a pre-registered contact, such as a message or alert, that conveys information about a detected risk of fraudulent activity.
The term “pre-registered contact” refers to a communication destination, such as a phone number, electronic mail address, or messaging account, which is registered in advance in association with a user for receiving notification information.
The term “secure communication path” refers to a communication channel established between the terminal and the server that employs security techniques, such as encryption and authentication, to protect the confidentiality and integrity of transmitted data.
The term “information processing method” refers to a computational procedure, such as an algorithm or a set of algorithms, executed by the processor to transform input data into an output, including feature extraction, rule matching, and classification.
The term “feature extraction” refers to processing that derives numerical or symbolic descriptors from character information, which capture salient aspects of the communication content for use in subsequent analysis.
The term “rule matching” refers to processing that compares character information or extracted features against predefined patterns or rules, such as regular expressions or heuristic conditions, to detect indications of fraudulent activity.
The term “classification processing” refers to processing that assigns one or more labels or categories to character information based on extracted features, rules, or model outputs, thereby categorizing the information with respect to fraud risk or other criteria.
The term “structured response format” refers to an arrangement of output data, such as a key-value pair representation or a hierarchical data structure, that allows the processor to systematically parse fields such as the numerical risk index and explanation information.
The term “explanation information” refers to text or structured data generated by the generative AI model that describes reasons or factors underlying the evaluation of the possibility of fraudulent activity.
The term “sequentially transmitted” refers to a mode of data transmission in which preprocessed character information corresponding to a communication is sent in portions over time, for example as the communication progresses.
The term “in real time” refers to processing that is performed with a latency sufficiently low that the system can generate warnings or control signals during an ongoing communication session, rather than only after the communication has ended.

In one embodiment, a server cooperates with a terminal operated by a user to implement the claimed system. The server comprises at least one processor, a memory storing executable instructions, a communication interface, and a storage device. The terminal comprises a processor, a memory, a communication module, an audio input device such as a microphone, and a display device such as a touch screen. The server and the terminal are connected via a communication network such as a cellular network or a wireless local area network using standard network protocols.

The terminal acquires audio information and character information during communications of the user. The terminal uses an audio input device and an operating system audio API (for example, an audio capture framework in a mobile operating system) to sample audio waveforms of a voice call. The terminal converts the sampled audio into digital audio data, for example, pulse code modulated (PCM) data or compressed audio data. The terminal also acquires character information directly from message applications via application programming interfaces or content providers. The terminal may execute a speech recognition software component such as a general speech-to-text engine or an on-device automatic speech recognition model to convert the audio information into character information. The terminal uses a natural language processing library such as a tokenization module or a morphological analysis library to normalize the character information, remove noise tokens, and generate structured text segments corresponding to utterances or messages.

The terminal associates the character information with additional information. The terminal attaches communication time information, such as a start time stamp, an end time stamp, and a duration, to each text segment. The terminal also attaches caller identification information, such as a caller number, a recipient number, or an account identifier. The terminal stores this combined data in a structured data format, for example, a record including fields for session identifier, utterance index, normalized text, time stamp, and party role (caller or callee). The terminal compresses or encrypts this structured data and transmits it to the server via a secure communication path using a transport layer security protocol.

The server receives the preprocessed character information and the additional information from the terminal and stores them in a storage device. The server uses a database management system to store each communication session as a set of records, each record including text content, communication time information, caller identification information, and any associated flags. The server indexes the database by session identifier and time stamp to support efficient retrieval of partial transcripts during an ongoing communication. The server may cache recent records in a volatile memory to reduce access latency.

The server generates a prompt sentence for a generative AI model based on the received information. The server uses the processor to apply an information processing method that includes feature extraction, rule matching, and classification processing to the character information. The server computes textual features such as n-gram frequency vectors, part-of-speech tag distributions, presence of sensitive keyword patterns (for example, “bank account number,” “password,” “transfer immediately”), and structural features such as the presence of numerical sequences or hyperlinks. The server may also compute conversation-level features such as the relative position of the utterance in the session, repetition of certain requests, or escalation phrases.

The server compares the extracted features with predefined rule sets implemented as pattern expressions or decision tables. The server classifies each utterance or group of utterances into preliminary categories such as “credential request,” “identity verification,” or “payment instruction.” This classification is implemented by a deterministic algorithm that maps combinations of feature values to category labels. The server uses the classification results and feature vectors to select a prompt template and to summarize or segment the character information before embedding it into the prompt sentence.

The server constructs the prompt sentence as a natural language instruction for the generative AI model. The server specifies in the prompt sentence the definition of fraudulent activity to be used, the desired output format, and evaluation criteria. For example, the server may generate a prompt sentence such as:
“You are a fraud detection assistant. Analyze the following communication content and determine whether there is a possibility of fraud. Evaluate the content according to the following definition: ‘fraudulent activity’ includes any attempt to illicitly obtain financial information, authentication credentials, or personal information by deception or coercion. Assess the risk on a scale from 0.0 (no fraud) to 1.0 (certain fraud). Return as output a field ‘risk_score’ and a field ‘explanation’ describing the key reasons. Communication content: [normalized text].”

The server may also generate a shorter prompt sentence such as:
“Please determine whether there is a possibility of fraud in the following call transcript and output a risk score between 0 and 1 with a brief explanation. Transcript: [normalized text].”

The server embeds in place of [normalized text] one or more utterances, possibly truncated or summarized according to length constraints. The server may segment a long transcript into multiple prompt sentences, each covering a time window, to allow streaming analysis by the generative AI model.

The server inputs the prompt sentence into the generative AI model. In one embodiment, the generative AI model is implemented as a neural network language model based on a transformer architecture. The generative AI model includes an input embedding layer that maps tokens of the prompt sentence to dense vectors, a plurality of self-attention layers that compute contextualized representations, and an output layer that generates tokens of the output text. The server uses a model that has been fine-tuned on a corpus of communication data labeled for fraud risk. During training, the server uses a supervised learning method in which each input prompt is associated with a target output including a risk score and explanation text. The server defines a loss function that includes a regression loss term for the risk score (for example, mean squared error between predicted and target scores) and a language modeling loss term for the explanation text (for example, cross-entropy loss). The server updates model weights using a gradient-based optimization algorithm such as stochastic gradient descent or a variant such as Adam, with learning rate, batch size, and regularization parameters stored in configuration. The server may apply data augmentation methods such as paraphrasing, masking of non-critical tokens, or synthetic generation of fraudulent and non-fraudulent examples to increase robustness of the model.

In another embodiment, the server uses an external generative AI service accessible via an application programming interface. The server formats the prompt sentence and transmits it to the external model, and then parses the returned text to extract the risk score and explanation. The server restricts the output format by including in the prompt explicit instructions such as “Return the risk score as a single number between 0 and 1, followed by the explanation in one or two sentences.” This configuration improves parsability and reduces errors in subsequent numerical processing.

The server receives an evaluation result from the generative AI model. The evaluation result includes at least a numerical risk index and explanation information. The server uses a parser to locate and convert the risk index into a numeric type and to separate the explanation text. The server may apply sanity checks to ensure the risk index lies within a valid range and to handle exceptional or malformed outputs. The server writes the risk index and explanation text into the database, linked to the corresponding communication session, time stamp, and prompt sentence.

The server determines a risk level of fraudulent activity by comparing the numerical risk index with one or more predetermined thresholds. The server may store in configuration a warning threshold and an action threshold. When the numerical risk index is less than the warning threshold, the server treats the communication as low risk and may only log the result. When the numerical risk index is between the warning threshold and the action threshold, the server treats the communication as medium risk and may schedule a non-intrusive warning operation. When the numerical risk index is greater than or equal to the action threshold, the server treats the communication as high risk and generates one or more control signals for protective operations.

The server generates control signals that are translated into device-level commands. The server may generate a control signal instructing the terminal to store a call record or communication record. In this case, the server constructs a message that causes the terminal to maintain or initiate recording of the audio information, to associate the recording with the session identifier, and to store it in a secure storage area. The server may generate a control signal instructing the terminal to display warning information to the user. In this case, the server includes in the control signal a warning message and severity level. The terminal uses its display device and operating system notification framework to show a banner or full-screen message such as “High fraud risk detected. Do not provide bank account information or passwords.” The server may also generate a control signal instructing the transmission of notification information to a pre-registered contact. In this case, the server prepares message content summarizing the time, risk level, and key explanation details and uses a communication interface to send the notification via a messaging protocol, electronic mail protocol, or short message service.

The terminal receives control signals from the server and enforces the instructed operations. The terminal processes a control signal that requests recording by ensuring that an audio capture service is active, writing the captured audio into a file, and marking the file with appropriate metadata. The terminal may encrypt the file and upload it back to the server's storage device. The terminal processes a control signal that requests display of a warning by rendering a graphical element or pop-up on the screen during the ongoing communication. This real-time feedback allows the user to modify behavior, for example, by refusing to share sensitive information or by terminating the call.

The server repeatedly executes the evaluation cycle during an ongoing communication. Because the terminal transmits segments of character information as they are generated, the server updates a time-series of risk indices. The server can detect rapid increases in risk index values and can generate control signals during the communication. This iterative and streaming architecture differs from batch analysis of offline call recordings and enables a reduction in detection latency. The technical effect is that the server maintains a continuously updated machine-interpretable risk index that is coupled to automated device control operations, improving responsiveness compared to conventional systems that only classify completed sessions.

The server improves computer technology by optimizing the structure of data and the interaction between the generative AI model and the rest of the system. By embedding explicit evaluation criteria and output format requirements in the prompt sentence and by transforming heterogeneous communication data into structured inputs, the server reduces the computational overhead of post-processing free-form model outputs. The server can parse the structured output with deterministic algorithms, which reduces error rates and parsing time. Additionally, by pre-filtering and summarizing character information based on feature extraction and rule matching, the server reduces the token length of the prompt sentence and lowers computational load on the generative AI model, thereby decreasing inference time and communication bandwidth consumption when an external model is used.

The server uses specific internal data structures to support these technical improvements. For example, the server may represent each communication session as a graph or sequence of utterance nodes, each node storing text, time stamp, speaker role, and risk index values. The server may maintain rolling window aggregates such as average risk index over the last N utterances or maximum risk index within a recent time interval. These aggregates feed into decision rules that determine when to generate control signals. This structured representation allows efficient retrieval and update operations using indexed database queries and in-memory caching, improving throughput under high communication volume.

The terminal and the server cooperate in a non-conventional way that is not a mere automation of manual fraud review. The generative AI model does not simply replicate human pattern recognition, but instead uses high-dimensional feature representations and attention mechanisms in the transformer architecture to capture subtle contextual dependencies across multiple utterances, such as gradual escalation of urgency or repeated credential requests. The feature extraction and prompt generation logic on the server ensures that these contextual cues are presented to the model in a compact but informative manner. As a result, the system can achieve higher detection accuracy and lower false positive rates than systems relying only on simple keyword matching or static rule engines.

In another embodiment, the server uses a variant neural network architecture such as a hybrid model combining convolutional layers for local pattern detection with transformer layers for long-range dependency modeling. The server may also incorporate a calibration layer or a secondary classifier that takes as input the raw risk index and additional features (for example, call duration, number of credential requests, or historical risk scores for the same caller) and outputs an adjusted risk index. This secondary classifier may be trained using a logistic regression algorithm or a gradient boosting method, with a loss function designed to optimize detection performance metrics such as area under the receiver operating characteristic curve.

In yet another embodiment, the server implements different prompt templates and threshold sets for different application domains, such as financial services, technical support scams, or social engineering scenarios. The server selects a template and threshold configuration based on caller identification information, communication channel type, or user preferences. This flexibility allows technical optimization for different risk profiles without changing the overall system architecture.

The user configures the system through the terminal. The user selects which types of communications are monitored, chooses sensitivity levels, and registers contacts for notifications. These settings are transmitted to the server and stored as policy parameters that influence threshold values and enabled operations. The server applies these parameters when generating control signals, thereby adapting the system behavior to user requirements while maintaining the same underlying technical processing chain.

Through these embodiments, the server and the terminal collectively implement a concrete, technical solution that improves the functioning of a computer-implemented fraud detection system. The coordinated use of structured preprocessing, prompt sentence generation with explicit constraints, transformer-based generative AI models, numerical risk index computation, and device-level control signals achieves improved processing speed, higher evaluation accuracy, reduced communication overhead, and deterministic, machine-actionable responses, rather than merely automating a human decision-making process.

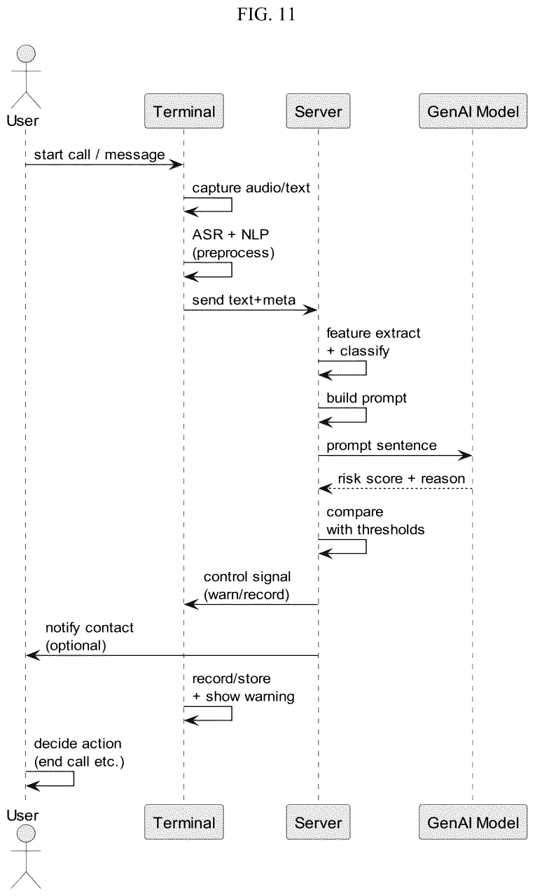

The following describes the processing flow using FIG. 11.

### Step 1:

The terminal starts monitoring of communications initiated or received by the user.

The terminal uses an operating system interface for telephony and messaging to detect an event such as an incoming call, an outgoing call, or a newly received text message.
Input: System events indicating call start, call end, message send, or message receive.

The terminal, based on these events, activates an audio capture module for voice communications and a text acquisition module for message communications. The terminal configures sampling parameters such as sampling rate and buffer size and allocates memory buffers for upcoming data.
Output: Active capture contexts, each including a session identifier, communication type (voice or text), and initialized buffers for audio data or text data.

### Step 2:

The terminal acquires raw communication data from the user and the remote party.

The terminal uses a microphone interface and audio APIs to capture audio waveforms during a call and reads text content from messaging applications or system message stores for textual communications.
Input: For voice calls, analog voice signals from the microphone and call control metadata from the telephony stack; for text messages, message objects from messaging APIs containing sender, recipient, and body fields.

The terminal digitizes analog signals into sequences of audio samples, segments them into time-framed buffers, and stores them as digital audio data. The terminal copies text message bodies into internal data structures without modification at this stage.
Output: Raw digital audio buffers associated with session identifiers, and raw text message objects associated with session identifiers.

### Step 3:

The terminal converts raw audio data into character information.

The terminal invokes a speech recognition engine that operates either locally or via a cloud service to transcribe the audio buffers into text.
Input: Raw digital audio buffers labeled with session identifiers, time stamps, and direction (incoming or outgoing audio).

The terminal sends audio chunks to the speech recognition engine, which computes acoustic features (such as mel-frequency cepstral coefficients), applies an acoustic model and language model, and outputs recognized text segments with confidence scores. The terminal concatenates successive recognized segments, resolves overlapping or low-confidence segments according to predefined rules, and attaches time stamps representing when each segment was spoken.
Output: Transcribed text segments (character information) corresponding to the audio communication, each annotated with session identifier, time stamp, and speaker direction.

### Step 4:

The terminal performs preprocessing on character information and associates additional information.

The terminal uses a natural language processing library to normalize text and to attach metadata.
Input: Transcribed text segments from voice calls and raw text message objects from messaging applications.

The terminal performs operations such as lowercasing, removal of non-informative symbols, tokenization into words or subwords, and optional language detection. The terminal then attaches additional information including communication time information, caller identification information, and conversation context identifiers. The terminal organizes this into a structured record for each segment, for example, {session_id, segment_id, normalized_text, timestamp, caller_id, callee_id, direction}.
Output: Preprocessed character information records, each containing normalized text and associated additional information.

### Step 5:

The terminal packages and transmits preprocessed data to the server via a secure communication path.

The terminal uses a network communication module to create a request payload and send it over a secure channel.
Input: Preprocessed character information records with associated additional information.

The terminal groups recent records by session identifier into small batches, serializes them into a structured payload, and encrypts the payload using a security protocol. The terminal sends the encrypted payload to the server using an authenticated request and, if necessary, queues retransmission attempts when connectivity is poor.
Output: Encrypted request messages delivered to the server, each containing a batch of preprocessed character information records and metadata.

### Step 6:

The server receives and stores preprocessed communication data.

The server uses a communication interface and a database management component to ingest and persist data.
Input: Encrypted request messages from the terminal containing batches of preprocessed character information and additional information.

The server decrypts each message, verifies authentication tokens, and parses the payload to recover structured records. The server writes these records into a database, indexing them by session identifier and time stamp, and optionally caches recent records in memory for fast access.
Output: Persistent database entries and in-memory cache entries representing ongoing communication sessions with associated text and metadata.

### Step 7:

The server performs feature extraction and preliminary classification on the character information.

The server applies an information processing method to derive features from the stored text segments.
Input: Preprocessed character information records retrieved from the database or cache for one or more recent segments of a session.

The server computes textual features such as token frequencies, presence of sensitive keywords, positions of numeric sequences, and counts of imperative phrases. The server may also compute temporal features such as time intervals between utterances and the progression of similar requests. The server applies rule matching using predefined patterns to detect occurrences of phrases like “bank account number,” “password,” or “transfer now.” Based on these features and patterns, the server classifies each segment into categories (for example, information request, authentication request, payment instruction) using a simple classifier such as a decision tree or rule-based mapping.
Output: Feature vectors and classification labels associated with each preprocessed character information record, stored either in memory or in extended database fields.

### Step 8:

The server generates a prompt sentence to instruct a generative AI model.

The server constructs a natural language instruction incorporating the character information, extracted features, and evaluation criteria.
Input: Recent preprocessed character information records for a session, their associated feature vectors, classification labels, and configuration data defining fraudulent activity and output format.

The server selects a prompt template based on the classification labels, determines how many text segments to include, and may summarize longer text by selecting representative sentences that contain high-risk features. The server then constructs a prompt sentence such as:
“You are a fraud detection assistant. Analyze the following communication and determine whether there is a possibility of fraud. Assess risk on a scale from 0.0 to 1.0. Return a risk score and a brief explanation. Communication: [normalized text].”

The server embeds the selected normalized text segments and appends or incorporates definitions such as what constitutes fraudulent activity and which fields should appear in the output.
Output: A complete prompt sentence tailored to the current communication context, ready for input to a generative AI model.

### Step 9:

The server inputs the prompt sentence into a generative AI model and obtains an evaluation result.

The server invokes a neural network language model to process the prompt.
Input: The prompt sentence containing communication content, definitions, and required output format.

The server tokenizes the prompt sentence according to the input requirements of the generative AI model, generates token embeddings, and feeds them through a multi-layer transformer network with self-attention mechanisms. The model processes the prompt and generates an output sequence that includes a numerical expression of a risk score and explanatory text. The server collects the output tokens, decodes them into text, and then parses out the risk score and explanation using deterministic parsing rules.
Output: An evaluation result including a numerical risk index and explanation information associated with the analyzed communication segments.

### Step 10:

The server determines a risk level by comparing the numerical risk index with thresholds.

The server uses configuration parameters and simple arithmetic operations to map the numerical value to discrete levels.
Input: A numerical risk index derived from the evaluation result and stored threshold values such as a warning threshold and an action threshold.

The server evaluates conditions such as “risk_index<warning_threshold,” “warning_threshold≤risk_index<action_threshold,” and “risk_index≥action_threshold.” The server assigns a risk level label (for example, low, medium, or high) based on these comparisons. The server logs the numerical index and risk level in the database for the session.
Output: A risk level classification and a record of the risk index associated with the session and corresponding time segment.

### Step 11:

The server generates control signals when the risk level matches predefined conditions.

The server translates risk level decisions into specific actions directed at the terminal and external devices.
Input: The risk level classification, numerical risk index, session identifier, and user policy settings indicating which actions are enabled.

The server constructs control signal messages specifying operations such as “store_call_record,” “display_warning,” and “send_notification.” For a high-risk level, the server may include a warning message for the user and a summary of the explanation text for external contacts. The server formats these control signals and queues them for delivery via push notification services or internal messaging subsystems.
Output: One or more control signal messages bound to a session identifier, ready for transmission to the terminal and, if needed, to external communication modules.

### Step 12:

The terminal receives and enforces control signals from the server.

The terminal processes incoming messages to apply protective operations during the communication.
Input: Control signal messages from the server specifying actions such as recording, warning display, or additional data upload.

The terminal decodes the control signal, checks the current communication state (for example, whether a call is ongoing), and executes the requested operation. To store a call record, the terminal maintains the audio capture module active, writes audio data to a secure file, and tags the file with the session identifier and time range. To display a warning, the terminal uses the display device to render a visual notification such as “Warning: High fraud risk detected. Do not share financial information.” If instructed, the terminal may upload stored recordings or transcripts back to the server using the secure communication path.
Output: Updated local storage containing call or communication records, visible warning information shown to the user, and optional additional data transmitted back to the server.

### Step 13:

The server notifies pre-registered contacts when configured conditions are met.

The server uses external communication channels to inform third parties of high-risk situations.
Input: Control decision information indicating that external notification is required, user configuration listing pre-registered contacts, and explanation information generated by the generative AI model.

The server composes notification messages summarizing the nature of the risk, including elements such as the time of the communication, the evaluated risk level, and a short description derived from the explanation text. The server then sends these notifications via an electronic mail service, a messaging service, or a short message service gateway. The server records the fact of notification, including destination and time, in the database.
Output: Outgoing notification messages delivered to pre-registered contacts and log entries documenting the notifications.

### Step 14:

The user reacts to feedback provided by the terminal and the server.

The user uses the visible warnings and, optionally, subsequent review interfaces to decide on further actions.
Input: Warning information displayed on the terminal, ongoing communication context, and possibly follow-up notifications received from contacts.

The user, upon seeing a warning such as “High fraud risk detected,” may terminate the call, refuse to provide sensitive data, or request further verification from the remote party. After the communication ends, the user may open an application on the terminal to review stored incidents, including the risk index and explanation text. The user may label the incident as confirmed fraud or false positive, and the terminal can send this feedback to the server for future model calibration.
Output: User actions such as call termination or refusal to share information, and optional feedback data transmitted to the server for refinement of processing logic.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional fraud detection systems that monitor communications such as voice calls and text messages typically rely on fixed keyword lists, rule-based pattern matching, or standalone statistical classifiers. These systems suffer from several technical limitations. First, such systems often process audio and text data in separate, uncoordinated pipelines, which leads to incomplete utilization of multi-modal information and reduced detection accuracy. Second, conventional systems usually pass raw or minimally processed text directly to a generative model or to a simple classifier, without constructing structured, machine-understandable indicator information or evaluation feature values that reflect semantic fraud patterns, such as monetary requests or references to persons in positions of authority. As a result, the systems may generate false positives and false negatives, and may be unable to provide reliable, context-aware warnings in real time.

Furthermore, existing architectures frequently treat a generative AI model as a passive post-processing component that simply labels or rephrases content, without integrating the model's explanatory outputs into a closed-loop decision mechanism for operation control. Such architectures do not combine the internal numerical evaluation values derived from conventional machine learning techniques with the qualitative explanations produced by a generative AI model, and therefore cannot dynamically adjust warning levels or execution behaviors based on both quantitative and qualitative assessments. This limits the system's ability to make fine-grained, real-time control decisions that are tailored to the specific communication context.

Additionally, many known systems do not provide a structured way to generate prompt sentences that are optimized for the generative AI model based on machine-derived evaluation feature values and indicator information. Without dynamically constructed prompt sentences that encode fraud-related features, the generative AI model may operate inefficiently, consuming more computation resources and network bandwidth, while producing less accurate and less actionable outputs. This results in unnecessary latency, increased processing load, and an inability to scale to large volumes of communication data.

Accordingly, there is a need for an improved computer-implemented technique that (i) unifies audio and text streams into communication-unit analysis target information, (ii) performs semantic analysis and feature extraction to generate structured indicator information and evaluation feature values related to fraudulent activity, and (iii) tightly integrates a generative AI model by generating optimized prompt sentences and by combining the model's outputs with machine-derived evaluation values. Such a technique should enable a processor to control warning presentation, communication record storage, and external notifications in real time, thereby improving the technical performance, efficiency, and reliability of fraud detection in communication monitoring systems.

The specific processing by the specific processing unit 290 of the data processing device 12 in Application Example 1 is realized by the following means.

The present invention provides a server comprising a processor and at least one memory storing instructions that, when executed by the processor, cause the processor to acquire audio information and character information from communication data, convert the audio information into character information by using a speech recognition technique, and integrate the character information and the converted character information to generate analysis target information for each communication unit; perform semantic analysis processing and feature extraction processing on the analysis target information by using a natural language processing technique and a machine learning technique to generate indicator information including terms, expressions, monetary requests, and expressions indicating persons in positions of authority that are related to fraudulent activity, and to generate evaluation feature values regarding a possibility of fraudulent activity on the basis of the indicator information and the analysis target information; execute evaluation processing to determine the possibility of fraudulent activity on the basis of the evaluation feature values, generate evaluation input information including a determination result and the indicator information, and generate a prompt sentence for input to a generative AI model on the basis of the evaluation input information; input the prompt sentence to the generative AI model, acquire a generated result output from the generative AI model, the generated result including the possibility of fraudulent activity and grounds for the possibility, and determine operation control information including at least one of presentation of warning information in accordance with the possibility of fraudulent activity, storage of communication record information, and transmission of notification information to a pre-registered contact, on the basis of the determination result and the generated result; and control an information output mechanism and a storage mechanism in accordance with the operation control information, and execute at least one of outputting a warning to a user, storing record information regarding communication content, and transmitting a warning notification to an external device. This enables the computing system to improve the technical process of fraud detection by efficiently transforming multi-modal communication data into structured evaluation feature values, dynamically generating optimized prompt sentences for a generative AI model, fusing numerical evaluation values with explanatory outputs from the generative AI model, and performing real-time, fine-grained operation control, thereby enhancing detection accuracy, reducing processing overhead, and providing timely protective actions for the user.
The term “audio information” refers to digital data representing sound signals captured from a communication, including but not limited to voice signals from telephone calls or voice messages, which are processable by a computing device.
The term “character information” refers to digital data representing textual content, including but not limited to text messages, chat messages, transcribed speech, and any other symbol sequences expressed in a written language and processable by a computing device.
The term “speech recognition technique” refers to a computational method or algorithm that converts audio information into character information by analyzing acoustic features and mapping them to linguistic units.
The term “analysis target information” refers to aggregated and normalized character information corresponding to a unit of communication, obtained by integrating original character information and character information converted from audio information, and used as input for subsequent analysis processing.
The term “communication unit” refers to a logically grouped portion of communication, such as an individual call session, message thread, or time-bounded segment thereof, that serves as a unit for analysis and evaluation.
The term “semantic analysis processing” refers to processing that interprets the meaning or context of character information, including but not limited to part-of-speech tagging, syntactic parsing, entity recognition, and determination of semantic relationships among words or phrases.
The term “feature extraction processing” refers to processing that derives structured attributes or numerical representations from analysis target information, including but not limited to keyword indicators, entity types, syntactic patterns, and statistical measures, for use in further evaluation.
The term “natural language processing technique” refers to a computational technique for analyzing and processing human language text, including but not limited to tokenization, parsing, entity recognition, and language modeling.
The term “machine learning technique” refers to a computational method in which a model is trained on example data to recognize patterns or make predictions, including but not limited to classification algorithms, regression algorithms, and pattern recognition algorithms.
The term “indicator information” refers to structured information derived from analysis target information that indicates presence, absence, or intensity of elements related to fraudulent activity, including terms, expressions, monetary references, and references to persons in positions of authority.
The term “evaluation feature values” refers to numerical or structured values derived from indicator information and analysis target information that quantify characteristics relevant to assessing a possibility of fraudulent activity.
The term “possibility of fraudulent activity” refers to a likelihood or degree, expressed for example as a probability or score, that a given communication unit involves or relates to fraudulent behavior.
The term “evaluation processing” refers to computational processing that uses evaluation feature values to compute a determination result regarding the possibility of fraudulent activity, including but not limited to applying a classification model or thresholding operation.
The term “determination result” refers to an output of evaluation processing that indicates, for a given communication unit, whether fraudulent activity is suspected, and optionally a corresponding level or category of risk.
The term “evaluation input information” refers to combined information including at least the determination result and indicator information, which is prepared as input context for a generative AI model.
The term “prompt sentence” refers to a machine-generated natural language or structured instruction supplied to a generative AI model, specifying a task or question such as evaluating a possibility of fraudulent activity, and including contextual information derived from evaluation input information.
The term “generative AI model” refers to a computational model that generates text or structured data in response to an input prompt sentence, based on learned parameters obtained through training on example data.
The term “generated result” refers to output information produced by the generative AI model in response to a prompt sentence, including at least an assessment of the possibility of fraudulent activity and explanatory information indicating grounds for the assessment.
The term “operation control information” refers to control data determined on the basis of the determination result and the generated result, specifying at least one operation to be executed by the system, such as presenting warnings, storing records, or transmitting notifications.
The term “warning information” refers to information intended to alert a user or another party to a potential fraudulent activity, including but not limited to text messages, audio messages, or visual indicators.
The term “communication record information” refers to stored data representing content or metadata of a communication unit, including but not limited to transcripts, audio recordings, timestamps, and associated evaluation results.
The term “notification information” refers to information transmitted to an external device or contact to inform about a detected possibility of fraudulent activity, including but not limited to summary alerts and risk indicators.
The term “pre-registered contact” refers to an entity, such as a person or external system, whose contact information is stored in advance in association with a user account or device for the purpose of receiving notifications.
The term “information output mechanism” refers to hardware and software components configured to present information to a user or external device, including but not limited to display units, audio output units, and communication interfaces.
The term “storage mechanism” refers to hardware and software components configured to store data, including but not limited to non-volatile memory, databases, and file systems.
The term “threshold determination processing” refers to processing that compares one or more numerical evaluation values with one or more threshold values to decide whether and how to trigger particular operations.
The term “warning level” refers to a classification or degree of urgency associated with warning information, determined in accordance with the assessed possibility of fraudulent activity.
The term “type of operation” refers to a category of action to be executed by the system, such as issuing a user alert, logging a communication, escalating to an external contact, or suppressing non-critical notifications.

In one embodiment, a server, a terminal, and a user cooperate to implement a communication monitoring system that evaluates a possibility of fraudulent activity by combining conventional machine learning with a generative AI model, and that controls concrete hardware components to provide real-time protection.

The server includes at least one processor, a memory storing program instructions and data structures, a network interface, and a storage mechanism such as a database system and a file system. The terminal includes at least one processor, a memory, a communication interface, an audio input mechanism such as a microphone, an audio output mechanism such as a speaker, a display, a vibration actuator, and a local storage device. The user operates the terminal in ordinary communication scenarios such as voice calls and text messaging.

The server stores and manages program modules that are distributed to the terminal. The server stores configuration data such as model parameters, threshold values, and prompt templates. The server also stores a trained generative AI model on a computing platform that has sufficient computing resources (for example, a server-class processor and a graphics processing unit). The server, in some embodiments, exposes an application programming interface to which the terminal transmits prompt sentences and from which the terminal receives generated results.

The terminal executes a monitoring application installed on a portable information processing device. The terminal uses an operating system telephony framework to capture audio information from calls and uses an operating system messaging framework to obtain character information from text messages and communication applications. The terminal, in one example, uses a speech recognition service such as a cloud-based speech-to-text application programming interface to convert audio information into character information. The terminal performs local pre-processing of the audio stream to segment the stream into time windows and to encode the stream in a format accepted by the speech recognition service.

The terminal normalizes character information acquired from different sources. The terminal converts character encodings, removes extraneous control symbols, and aligns time stamps between audio-derived character information and originally textual messages. The terminal stores this aggregated and normalized character information as analysis target information for each communication unit. The analysis target information is held in a structured data format that associates text segments with metadata such as a communication identifier, a direction flag indicating incoming or outgoing, and a communication type code.

The terminal performs semantic analysis processing and feature extraction processing on the analysis target information by using a natural language processing technique and a machine learning technique. The terminal, for example, uses a linguistic processing library to tokenize text, assign part-of-speech tags, perform dependency parsing, and detect named entities such as personal names, organization names, monetary amounts, and dates. The terminal represents each token, sentence, and entity in an internal data structure, such as a list of token objects, each token object including a lemma field, a part-of-speech field, and a dependency relation field.

The terminal generates indicator information that encodes elements related to fraudulent activity. The terminal, for example, detects tokens and n-gram sequences that match patterns indicating monetary requests, urgent actions, or references to persons in positions of authority. The terminal records counts of such patterns, flags indicating presence of specific semantic categories, and relative positions of these patterns within the communication unit. The terminal stores indicator information in a feature dictionary structure in which keys correspond to fraud-related attributes (for example, “has_monetary_amount,” “mentions_authority,” “urgency_expression_count”) and values correspond to counts or boolean indicators.

The terminal generates evaluation feature values based on the indicator information and the analysis target information. The terminal, in one implementation, applies a term frequency-inverse document frequency transformation to n-gram representations of the text, and uses a vectorization module to transform indicator information into a sparse feature vector. The terminal may further append metadata-based features such as communication duration, number of speaker turns, and ratio of numeric tokens to alphabetic tokens. The terminal thereby forms a multi-dimensional feature vector that is suitable as input for a classifier.

The terminal executes a pre-trained machine learning model, such as a logistic regression model, a decision tree ensemble model, or a neural network classifier, on the evaluation feature values to compute a numerical evaluation value representing the possibility of fraudulent activity. The terminal, for example, uses a logistic regression classifier having a weight vector and a bias term, and computes a fraud probability score as a logistic function of a dot product between the evaluation feature vector and the weight vector. The terminal may alternatively or additionally use a tree-based ensemble that computes an average of decision tree outputs. The terminal outputs a determination result that includes a categorical label (for example, “fraud suspected” or “not fraud suspected”) and the associated numeric probability.

The terminal constructs evaluation input information that includes the determination result, the evaluation feature values, and at least a subset of the indicator information. The terminal prepares this evaluation input information as context to be encoded in a prompt sentence for a generative AI model. The terminal, in one embodiment, uses a template that places feature summaries and selected text excerpts into natural language instructions, such as “The following message mentions a request to transfer money and references a law enforcement officer. Evaluate the likelihood of fraud and explain your reasoning.”

The server stores and executes the generative AI model that receives the prompt sentence and produces a generated result. The generative AI model, in one embodiment, is a transformer-based neural network that has an encoder-decoder architecture or a decoder-only architecture. The server stores neural network parameters such as layer weights, bias terms, attention matrices, and positional encoding vectors. The server uses a trained model that has been obtained through supervised or reinforcement learning on a large corpus of text data that includes examples of fraudulent and non-fraudulent communications. The server applies optimization techniques such as stochastic gradient descent or Adam during training, with an objective function that combines language modeling loss and task-specific loss related to correctness of fraud assessments.

The server receives the prompt sentence from the terminal through the network interface. The server applies tokenization and embedding operations to convert the prompt sentence into numerical representations. The server then propagates these representations through the neural network layers, computing attention scores, intermediate hidden states, and output logits. The server converts the logits into output tokens using sampling or greedy decoding. The server thereby generates a generated result that includes a qualitative description of the possibility of fraudulent activity and an explanation of grounds for that possibility, and may also include a structured risk score.

The terminal receives the generated result from the server. The terminal parses the generated result to extract the generative model's assessment of fraud likelihood and explanatory statements. The terminal combines this extracted information with the numerical evaluation value computed locally. The terminal performs threshold determination processing that uses both the numerical evaluation value and the generative model-derived risk indication. The terminal, for example, requires both a local probability exceeding a first threshold and a generative model classification of “likely fraud” to apply the highest warning level, thereby reducing false positives and improving precision.

The terminal determines operation control information in accordance with the combined assessment. The terminal sets a warning level, selects a type of operation to be executed, and selects specific content for warning information. The terminal controls an information output mechanism to display a text warning on the display, to play a synthesized audio warning on the speaker, and to activate the vibration actuator. The terminal controls the storage mechanism to allocate persistent storage for communication record information, including the transcript, the evaluation feature values, and the audio recording. The terminal optionally transmits notification information to a pre-registered contact through a messaging service or a push notification service, using network communication controlled by the processor.

The user perceives the warning and is able to take immediate protective actions, such as terminating the call or confirming the situation with a trusted party. The user may also review stored communication record information through a user interface implemented by the terminal, and may provide explicit feedback labels such as “fraud confirmed” or “not fraud.” The terminal uploads such feedback to the server to enable retraining or fine-tuning of the machine learning models and the generative AI model prompts.

The server, in one embodiment, periodically aggregates communication record information and feedback from multiple terminals to refine both the traditional classifier and the generative AI model usage. The server constructs training datasets that include evaluation feature values, labels derived from user feedback, and associated text content. The server retrains a classification model by minimizing a loss function such as cross-entropy loss, using weight update rules based on gradient descent. The server may employ data augmentation techniques, such as paraphrasing, random deletion of non-critical tokens, or noise injection into numeric amounts, to increase model robustness and reduce overfitting.

The server, in another embodiment, optimizes prompt sentence templates for the generative AI model by evaluating different template variants against held-out validation data and selecting templates that yield improved alignment between generative model outputs and ground-truth labels. The server thereby reduces communication bandwidth and latency by limiting prompt length while maintaining or improving fraud detection performance.

The system improves computer technology in several respects. The terminal and the server cooperate to perform feature extraction and model inference in a manner that reduces both computational cost and communication load. The terminal performs efficient vectorization and preliminary classification, allowing the server to allocate generative AI resources selectively to communications having non-trivial fraud probability. This selective invocation reduces network traffic and server load while maintaining high recall. The integration of indicator information into prompt sentences improves the generative model's ability to focus on relevant aspects, which reduces the number of tokens that must be generated and processed, thus improving processing speed.

The system also improves accuracy relative to conventional rule-based or single-model systems. The terminal uses a multi-dimensional feature representation that encodes semantic, syntactic, and metadata-level characteristics of communications. The server's generative AI model incorporates explanatory reasoning that can identify subtle cues of fraudulent activity that are not captured by purely statistical models. By combining numerical evaluation values with generative-model explanations, the system achieves lower error rates and can adapt dynamically to new fraud patterns.

The system improves data management by storing communication record information in a structured, queryable format that associates transcripts, feature vectors, and model outputs with communication units. The server can search and analyze this stored data to detect emerging fraud patterns, to refine models, and to adjust thresholds. The structured storage of indicator information enables efficient indexing and retrieval using database techniques, which improves performance when handling large volumes of communication records.

The system employs processing rules that differ from human manual procedures. The terminal and the server do not simply emulate a human operator reading messages and deciding about fraud. Instead, the system uses explicit feature encodings, vector operations, learned weight matrices, threshold conditions, and generative reasoning guided by precise prompt sentences. The system uses non-intuitive combinations of signals, such as particular dependency patterns coupled with numeric ratios and time-series characteristics, that are not practically accessible to human cognition at scale. This non-conventional processing leads to improved technical performance in detection tasks.

In one specific example, the terminal monitors an incoming call in which a caller claims to be a law enforcement officer and demands an immediate transfer of funds. The terminal converts the caller's voice into text, extracts entities such as “officer,” “accident,” and a monetary amount, and computes evaluation feature values indicating high urgency and a large requested transfer. The terminal's classifier outputs a fraud probability above a predetermined threshold. The terminal then composes a prompt sentence such as:
“You are a fraud-detection assistant. Analyze the following phone call transcript and determine whether it is likely to be a special fraud attempt targeting a user. List the risky phrases, explain why they are risky, and output: (1) a risk score from 0 to 1, (2) a short warning sentence for the user, and (3) a short alert sentence for the user's family. Transcript: [transcript text].”

The server receives this prompt sentence, processes it with the generative AI model, and returns a generated result including, for example, a risk score near one, an explanation that the caller claims authority and requests immediate payment, and a concise warning such as “This call shows multiple signs of a financial scam.” The terminal then escalates the warning level, displays the warning text, plays an audio alert, stores the audio recording, and sends a notification to the pre-registered contact.

In another example, the server uses a different prompt sentence optimized for short messaging, such as:
“Given this message conversation, identify if the sender is trying to trick the user into sending money or revealing personal information. If the risk is medium or high, generate a concise warning message that can be shown on a smartphone screen in less than 100 characters. Conversation: [message text].”

The server's generative AI model returns a brief warning that the terminal can display immediately, with minimal impact on user interface resources.

The server and the terminal, in alternative embodiments, may use different neural network architectures for the generative AI model, such as a recurrent neural network with attention or a convolutional sequence model, different loss functions such as margin-based losses, and different training protocols such as curriculum learning or continual learning. The evaluation feature values may be computed using other feature extraction techniques, such as embedding-based similarity measures or graph neural networks applied to dependency trees. The threshold determination logic may use fuzzy logic or multi-criteria decision making instead of simple scalar thresholds.

The system is not limited to a particular hardware platform. The server may be implemented on a distributed cluster, and the terminal may be any computing device capable of audio input, text display, and network communication, including a smartphone, a tablet, or a wearable device. The described functional modules may be implemented as dedicated hardware circuits, firmware components, or software executed by general-purpose processors.

By combining structured feature computation, targeted prompt sentence generation, and generative AI reasoning, and by tightly coupling these processes with concrete device control operations, the server and the terminal implement a technical solution that improves processing speed, accuracy, and resource utilization in fraud detection for communications, and that produces real-time protective actions for the user in the physical communication environment.

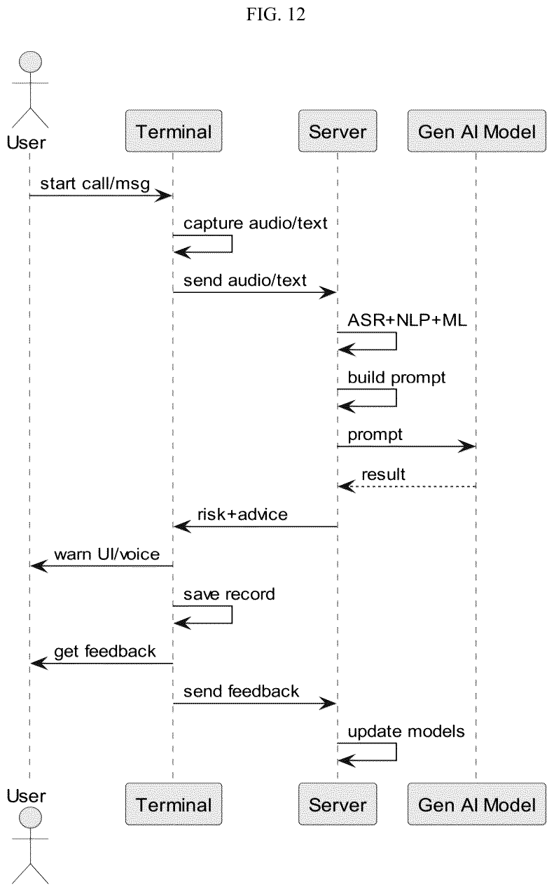

The following describes the processing flow using FIG. 12.

### Step 1:

The terminal initializes monitoring resources and configuration.

The terminal, as input, receives device status information from an operating system and configuration data from local storage, including monitored application identifiers, model versions, and threshold values. The terminal, based on this input, loads program modules, allocates memory buffers for audio and text data, and registers listeners with a telephony framework and messaging framework. The terminal outputs an initialized monitoring state in which audio input, notification access, and storage directories are ready for subsequent processing.

### Step 2:

The terminal acquires raw communication data.

The terminal, as input, receives event notifications indicating an incoming or outgoing call, a new text message, or an update from a communication application. The terminal, for voice calls, starts an audio capture component that reads audio samples from a microphone at a fixed sampling rate and stores them in a temporary buffer as pulse-code modulated data. For text messages and application notifications, the terminal reads character sequences and associated metadata such as sender identifier and timestamp. The terminal outputs raw audio data segments and raw character data segments, each tagged with a communication unit identifier and time index.

### Step 3:

The terminal converts audio information into character information.

The terminal, as input, uses the raw audio data segments and metadata indicating language and encoding format. The terminal performs data processing by compressing or formatting the audio into a representation accepted by a remote speech recognition service, and then transmits the formatted audio over a network interface. A remote speech recognition server returns recognized text as a sequence of characters with confidence scores. The terminal, based on this server output, aligns recognized text with original time indices and communication identifiers. The terminal outputs converted character information segments that correspond to the audio segments.

### Step 4:

The terminal generates analysis target information for each communication unit.

The terminal, as input, receives the converted character information from audio and the original character information from messages and notifications, along with associated metadata. The terminal performs data processing by normalizing encodings, removing control symbols, unifying character forms, and concatenating text segments in chronological order. The terminal then constructs an internal data structure that binds the integrated character data to a communication unit identifier, direction flag, and communication type. The terminal outputs analysis target information representing a complete textual view of each communication unit.

### Step 5:

The terminal performs semantic analysis processing on the analysis target information.

The terminal, as input, uses the analysis target information including integrated character sequences. The terminal executes a natural language processing module that tokenizes the text into lexical units, assigns part-of-speech tags, and computes syntactic dependency relations. The terminal further detects named entities such as persons, organizations, monetary amounts, and locations. The terminal, through these computations, transforms plain text into structured linguistic annotations. The terminal outputs annotated text objects containing tokens, part-of-speech labels, entity labels, and dependency relations associated with each communication unit.

### Step 6:

The terminal extracts indicator information related to fraudulent activity.

The terminal, as input, receives the annotated text objects and metadata such as communication direction and duration. The terminal executes rule-based and statistical pattern matching that identifies tokens and n-grams indicating monetary requests, urgent actions, references to law enforcement or similar authorities, and instructions for transferring assets. The terminal also counts occurrences of such patterns and records relative positions within the text. The terminal encodes these results in an indicator dictionary in which keys represent fraud-related attributes and values represent boolean flags or numeric counts. The terminal outputs indicator information associated with each communication unit.

### Step 7:

The terminal computes evaluation feature values from the indicator information and the analysis target information.

The terminal, as input, receives the indicator information and the underlying text from the analysis target information. The terminal performs feature extraction by applying a term frequency-inverse document frequency transformation to the text to produce a high-dimensional sparse vector, by mapping the indicator dictionary to a numerical feature vector, and by appending metadata-based features such as elapsed communication time and number of numeric tokens. The terminal concatenates and, if required, scales these vectors using a normalization operation. The terminal outputs evaluation feature values as numeric feature vectors that represent each communication unit in a form suitable for classification.

### Step 8:

The terminal evaluates the possibility of fraudulent activity using a conventional machine learning model.

The terminal, as input, uses the evaluation feature values and a stored machine learning model that includes parameters obtained during training, such as weight vectors and bias terms. The terminal performs numerical computations such as matrix multiplication, nonlinear activation, and probability calculation to derive a fraud probability score. The terminal then applies a classification rule, for example comparing the score to a predefined threshold, to decide whether the communication is suspected fraud. The terminal outputs a determination result that includes a categorical label and the associated numerical evaluation value for each communication unit.

### Step 9:

The terminal constructs evaluation input information for use with a generative AI model.

The terminal, as input, receives the determination result, the evaluation feature values, the indicator information, and a subset of the original text from the analysis target information. The terminal performs data processing by summarizing key fraud-related indicators, formatting numerical scores into human-readable text, and selecting representative excerpts from the communication content. The terminal combines these items into a structured context that includes explanation of detected patterns and their frequencies. The terminal outputs evaluation input information that will be encoded into a prompt sentence.

### Step 10:

The terminal generates a prompt sentence for a generative AI model.

The terminal, as input, uses the evaluation input information and a stored template for prompt construction. The terminal performs string processing to insert feature summaries, numerical scores, and text excerpts into positions defined by the template, while maintaining grammatical structure and explicit instructions to the generative AI model. The terminal may, for example, construct a prompt sentence such as: “You are a fraud-detection assistant. Analyze the following communication and determine whether it is likely to be a special fraud attempt. Explain which phrases indicate risk and output: (1) a risk score from 0 to 1, (2) a short warning sentence for the user, and (3) a short alert sentence for a guardian. Communication: [text excerpt].” The terminal outputs a finalized prompt sentence associated with the communication unit.

### Step 11:

The server processes the prompt sentence with a generative AI model.

The server, as input, receives the prompt sentence from the terminal through a network interface. The server tokenizes the prompt sentence into subword units, maps tokens to embedding vectors, and propagates these embeddings through a neural network architecture such as a transformer, layer by layer. The server computes self-attention scores, weighted sums of hidden states, and output logits for successive tokens. The server then decodes these logits to form a textual response that includes an assessment of fraud likelihood, an explanation of risky phrases, and suggested warning messages. The server outputs a generated result text that encodes both qualitative reasoning and, optionally, a numerical risk score.

### Step 12:

The terminal integrates the generated result with the determination result.

The terminal, as input, receives the generated result and has access to the previously computed determination result and numerical evaluation value. The terminal parses the generated result to extract key elements such as an explicit fraud classification, a risk score, and recommended warning text. The terminal then performs decision logic that combines the local numerical evaluation value with the generative model-provided assessment, for example by requiring both values to exceed corresponding thresholds for high-level warnings. The terminal outputs combined assessment data that specifies an overall risk level and recommended actions.

### Step 13:

The terminal determines operation control information based on the combined assessment.

The terminal, as input, receives the combined assessment data including the overall risk level and suggested warnings. The terminal executes control logic that maps risk levels to operational actions, such as setting a warning level, selecting visual and audio warning formats, deciding whether to store audio and text records, and deciding whether to notify external contacts. The terminal encodes these decisions as operation control information specifying parameters such as display text, audio prompt, storage file paths, and destination identifiers. The terminal outputs operation control information ready to drive device operations.

### Step 14:

The terminal executes warning, recording, and notification operations.

The terminal, as input, uses the operation control information. The terminal controls a display to present a warning message, controls a speaker to output a synthesized voice warning, and activates a vibration actuator to attract user attention. The terminal controls storage mechanisms to save communication record information, including audio files and transcripts, with identifiers for later retrieval. The terminal, if required, transmits notification information to a pre-registered contact through messaging or push notification services, embedding summary information about the suspected fraudulent activity. The terminal outputs completed device actions and records of executed operations.

### Step 15:

The user responds to warnings and provides feedback.

The user, as input, receives visual and audio warnings from the terminal and optionally receives notifications on external devices. The user inspects the warning content, may terminate an ongoing call, may contact a trusted party using the terminal, and may view stored communication details through a user interface. The user then provides feedback by selecting options such as “fraud confirmed,” “suspicious,” or “not fraud” within the application. The terminal records this user feedback as labeled data and outputs updated communication records that include user-supplied labels.

### Step 16:

The server updates models and prompt strategies using stored records and feedback.

The server, as input, receives communication records and user feedback labels from multiple terminals. The server aggregates evaluation feature values, determination results, generated results, and user labels into training datasets. The server performs data processing by shuffling, balancing classes, and optionally augmenting text data, then retrains or fine-tunes classification models using optimization algorithms such as stochastic gradient descent to minimize a loss function measuring misclassification error. The server also evaluates different prompt sentence templates by comparing generative model outputs against labeled ground truth. The server outputs updated model parameters and refined prompt templates that can be distributed to terminals to improve future detection accuracy and efficiency.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional fraud detection techniques for telephone or voice communications typically rely on fixed keyword lists, rule-based filters, or manual review of recorded calls. Such approaches suffer from several technical shortcomings when implemented in modern communication systems. First, rule-based detectors operate on limited patterns and cannot robustly adapt to evolving fraud tactics, which results in a high rate of false negatives or requires frequent manual rule updates. Second, systems that simply log audio and perform batch analysis after a call has ended cannot provide timely protection to a user, because the technical pipeline is not configured to perform low-latency end-to-end processing from audio capture to decision and notification. Third, even when advanced language models are available, existing systems generally invoke such models in an ad hoc manner, without a structured mechanism for generating tailored prompt sentences based on the temporal structure of the conversation, prior interaction history, and model-specific output formatting, leading to unstable or non-actionable outputs.

From a computer-technology standpoint, there is a further problem that conventional architectures do not organize streaming audio, intermediate character information, artificial intelligence evaluation, and alerting logic into a cohesive pipeline controlled by a single processor. In particular, conventional systems fail to (i) aggregate transcription results in time series and maintain a rolling analysis window suitable for continuous evaluation, (ii) dynamically construct and update prompt sentences that are optimized for a generative AI model and that encode evaluation criteria and output formats, and (iii) convert model outputs into normalized numerical risk scores that can be machine-processed to drive automated downstream operations such as recording, summarization, and notification. As a result, computing resources are inefficiently used, latency is high, and the system cannot reliably support real-time user protection.

Accordingly, there is a need for a computer-implemented system that improves the technical process of detecting unlawful activity in voice communications by tightly integrating audio acquisition, speech-to-text conversion, time-series text aggregation, generative AI model interaction via structured prompt sentences, numerical risk scoring, and automated alert workflows into a single processor-controlled architecture. Such a system should achieve improved responsiveness, robustness against evolving fraud patterns, and more efficient use of computational and network resources, thereby providing an improved fraud detection mechanism implemented by computer technology.

The specific processing by the specific processing unit 290 of the data processing device 12 in Example 2 is realized by the following means.

The present invention provides a server comprising a processor configured to acquire audio information from a communication apparatus during a communication session, convert the audio information into character information, aggregate the character information in time series and manage the aggregated character information as character information for an entire communication session, extract, from the character information for the entire communication session, character information corresponding to a predetermined time range and set the extracted character information as analysis target character information, generate a prompt sentence including the analysis target character information and conditions for evaluating a possibility of unlawful activity, input the prompt sentence into a generative information processing model and obtain an evaluation result indicating the possibility of unlawful activity with respect to the analysis target character information, numerically convert the possibility of unlawful activity for the communication session based on the evaluation result and, when a numerical value representing the possibility exceeds a threshold value, record the audio information and the character information of the communication session and generate summary information of the communication session, generate alert notification information based on the evaluation result and the summary information and transmit the alert notification information to a pre-registered destination, and transmit transmission status information of the alert notification information to a terminal and cause the terminal to display the transmission status information. This enables an integrated, computer-implemented fraud detection pipeline in which streaming audio is transformed into time-series character information, evaluated in near real time by a generative AI model using dynamically constructed prompt sentences, converted into machine-usable numerical risk scores, and used to automatically trigger recording, summarization, and alert notifications, thereby improving the technical performance, responsiveness, and reliability of fraud detection in communication systems.
The term “processor” refers to a hardware computation unit, such as a central processing unit or a microcontroller, configured to execute instructions stored in a memory to perform operations defined by software or firmware.
The term “audio information” refers to digital data representing sound acquired from a communication apparatus during a communication session, including but not limited to sampled voice signals encoded in any audio format.
The term “communication apparatus” refers to an electronic device capable of conducting voice communications over a network, such as a terminal device, a mobile communication device, a fixed-line communication device, or any other device that can send and receive audio signals.
The term “communication session” refers to a period of time during which a communication apparatus exchanges audio signals with another party, including but not limited to a telephone call, a voice-over-IP session, or any other real-time audio communication.
The term “character information” refers to data representing textual content obtained by converting audio information into a sequence of characters or symbols using speech recognition or similar processing.
The term “time series” refers to an ordered sequence of data elements, such as character information segments, arranged according to their occurrence time during a communication session.
The term “character information for an entire communication session” refers to an aggregation of character information corresponding to substantially all audio information of a given communication session, arranged in chronological order.
The term “predetermined time range” refers to a defined temporal interval within a communication session, such as a recent segment of conversation of specified duration, selected according to configuration parameters or control logic.
The term “analysis target character information” refers to a subset of character information extracted from the character information for an entire communication session that corresponds to a predetermined time range and is used as an input for evaluation processing.
The term “prompt sentence” refers to a text string including instructions and contextual data that is provided as input to a generative information processing model in order to cause the model to perform a specified evaluation or generation task.
The term “conditions for evaluating a possibility of unlawful activity” refers to rules, criteria, or guidelines expressed in natural language or structured form within a prompt sentence, which instruct a generative information processing model on how to determine whether provided character information indicates a likelihood of unlawful behavior.
The term “generative information processing model” refers to a computer-implemented model, such as a generative artificial intelligence model or a generative language model, configured to produce output information based on input information including prompt sentences and to perform tasks such as classification, evaluation, or text generation.
The term “evaluation result” refers to information output from a generative information processing model that indicates an assessed possibility of unlawful activity with respect to analysis target character information, and may include labels, scores, explanations, or other structured or unstructured data.
The term “possibility of unlawful activity” refers to a likelihood or risk that content represented by character information is associated with fraudulent, deceptive, or otherwise unauthorized behavior in a communication session.
The term “numerically convert” refers to processing that maps a qualitative evaluation result or descriptive assessment into a numerical value or score that can be compared with one or more threshold values by a processor.
The term “threshold value” refers to a numerical criterion used to distinguish between different risk levels, such that a numerical value representing a possibility of unlawful activity is judged to trigger or not trigger a specific operation based on whether the numerical value exceeds, meets, or falls below the criterion.
The term “summary information” refers to data that concisely expresses the main content, context, or suspicious aspects of a communication session, generated by processing character information and optionally using a generative information processing model.
The term “alert notification information” refers to information generated by a processor to inform a recipient of a detected possibility of unlawful activity, including at least an indication of risk and optionally summary information, contextual data, or links to additional data.
The term “pre-registered destination” refers to one or more recipient identifiers or addresses, such as contact identifiers, network addresses, or device identifiers, that are stored in advance and used as targets for transmitting alert notification information.
The term “transmission status information” refers to data indicating a state or result of an attempt to transmit alert notification information, such as success, failure, or pending, and optionally including timestamps or error details.
The term “terminal” refers to a user-operable electronic device, such as a mobile communication device, a computing device, or a display device, that can receive information from a server and present the information to a user.

In one embodiment, a server, a terminal, and a user cooperate to implement a system that detects a possibility of unlawful activity in a voice communication and performs recording, summarization, and alert notification based on a result of an analysis using a generative AI model. The server comprises a processor, a memory, at least one network interface, and a storage apparatus. The terminal comprises at least one processor, at least one microphone, a communication interface, and a display apparatus. The user operates the terminal in an ordinary manner to conduct a voice communication, while the server performs technical processing in the background.

The terminal uses telephony hardware and an audio input subsystem provided by an operating system, such as a mobile operating system audio framework, to acquire audio information during a communication session. The terminal converts analog sound captured by the microphone into digital samples using an audio codec implemented in dedicated audio hardware. The terminal stores the audio samples in a ring buffer in a memory of the terminal. The terminal transmits the buffered audio information to the server via a network interface, using a secure transport protocol such as a transport layer security protocol over a hypertext transfer protocol. By segmenting the audio into fixed-size frames and streaming them as the communication proceeds, the terminal enables the server to perform low-latency processing without waiting for the end of the call.

The server receives the audio information via the network interface and associates it with a session identifier and a user identifier. The server writes the raw audio information into a time-indexed data structure in a memory of the server, such as a sequence of fixed-length frames stored in a buffer array or a queue. The server may normalize the audio format using an audio processing library compliant with standard audio conversion functionality, thereby ensuring that the sample rate, channel configuration, and encoding conform to an expected format (for example, monaural linear pulse code modulation at sixteen kilohertz). This normalization step enables a downstream speech recognition engine to operate with reduced error rate and avoids repeated format conversion.

The server uses a speech recognition component to convert the audio information into character information. In one embodiment, the server employs a neural-network-based automatic speech recognition model such as an encoder-decoder architecture with an acoustic encoder and a language decoder. The server may implement this component using a commercially available speech recognition application programming interface or an open-source engine such as a sequence-to-sequence model. The server provides each normalized audio frame or group of frames to the speech recognition component together with configuration parameters specifying language and audio properties. The speech recognition component returns character information segments with associated time stamps. The server stores these character information segments in a database in association with the session identifier, and the server arranges them in a time series in the order of appearance in the communication session.

The server maintains, for each communication session, a data structure that aggregates the character information for substantially the entire communication session. This data structure can be implemented as a linked list of character segments, a time-indexed string buffer, or a document in a document-oriented database, in which each element contains character information, start time, end time, and metadata such as speaker identification, if available. By structuring the data in this way, the server can efficiently update the aggregated character information as new segments arrive, without reprocessing the entire transcript.

The server extracts analysis target character information corresponding to a predetermined time range from the aggregated character information. The server defines a sliding time window (for example, the latest thirty to one hundred eighty seconds of the conversation) and identifies character segments whose time stamps fall within this window. The server concatenates these segments to form a contiguous text string. The server annotates the extracted text with markers indicating speaker turns or detected entities when such information is available. The sliding window arrangement provides a technical effect of reducing processing load and latency for the analysis, because only a limited, recent portion of the communication session is evaluated at each invocation of the generative AI model.

The server generates a prompt sentence for a generative AI model based on the analysis target character information and on predetermined evaluation conditions. The server stores, in the memory, a template for the prompt sentence that includes instruction text, output requirements, and placeholders for the analysis target character information. The server fills the placeholders with the current analysis target character information, and optionally includes contextual attributes derived from past communication history, such as frequency of calls from the same caller or previous risk scores, in a structured way. The server also includes in the prompt sentence conditions for evaluating the possibility of unlawful activity, such as instructions to identify requests for money transfer, impersonation of institutions, or coercive language. The prompt sentence is a plain text string that the generative AI model can interpret.

In one example, the server generates and uses a prompt sentence of the following form:
“You are a system that detects the possibility of unlawful activity in telephone conversations targeting vulnerable users. Carefully analyze the following call transcript. Output only a label ‘HIGH’, ‘MEDIUM’, or ‘LOW’ indicating the risk, followed by a short explanation in English. Transcript: “Please wire the money. If the money were not wired immediately, it would become a serious matter.

In another example, the server uses a prompt sentence of the following form: “Act as an expert in detecting telephone fraud. Read the following transcript of a call. 1. Judge the possibility of unlawful activity as ‘HIGH’, ‘MEDIUM’, or ‘LOW’. 2. List key phrases that indicate potential unlawful activity. 3. Suggest a short warning message suitable for the user. Transcript: “I am a city staff, you will be able to receive a refund for medical payment. Please go and process an ATM within today.”

The server inputs the prompt sentence into a generative information processing model, which in one embodiment is implemented as a neural network-based generative AI model such as a transformer architecture. The generative AI model includes an embedding layer that converts tokens of the prompt sentence into vector representations, a plurality of self-attention layers that compute context-dependent representations for each token, and a feed-forward network that produces a sequence of output tokens. The server implements this model either by executing it locally using a machine learning framework or by invoking an external model service via an application programming interface, while still controlling the structure of the prompt and the interpretation of the output.

The server configures the generative AI model with parameters such as a maximum number of tokens for generation, a sampling temperature, and a decoding strategy (for example, greedy decoding or beam search). The server may pre-train or fine-tune the generative AI model using a training corpus consisting of annotated call transcripts, where each transcript is labeled with ground truth information about a presence or absence of unlawful activity. During training, the server updates model weights using an optimization algorithm such as stochastic gradient descent or an adaptive gradient method. The server minimizes a loss function such as a cross-entropy loss between predicted labels and ground truth labels or a sequence-level loss, and the server may apply regularization and data augmentation techniques such as random masking, synonym replacement, or noise injection in text to improve model generalization.

The server obtains an evaluation result from the generative AI model by parsing the textual output that the model produces in response to the prompt sentence. For example, the server extracts a label “HIGH”, “MEDIUM”, or “LOW” and a short explanation sentence that justifies the label. The server converts the label into a numerical score, such as assigning “HIGH” to 0.9, “MEDIUM” to 0.6, and “LOW” to 0.1. The server stores the numerical score and the explanation in association with the communication session in the database. By mapping the textual output into a numerical representation, the server can perform machine-based comparison with a threshold and can execute deterministic downstream actions without human intervention.

The server compares the numerical score with a threshold value that is stored in configuration data. When the score equals or exceeds the threshold value, the server classifies the communication session as having a high possibility of unlawful activity. The server then records the audio information and the character information of the communication session in persistent storage, such as a storage apparatus implementing a file system or an object storage service. The server may compress the audio information using an audio codec to reduce storage size while keeping sufficient fidelity for later review. The server also generates summary information of the communication session, for example by issuing another prompt sentence to the generative AI model that instructs the model to produce a concise description of suspicious content. An example of such a prompt sentence is:
“Summarize the following telephone conversation in 3 to 5 sentences, focusing on parts that indicate possible unlawful activity targeting a vulnerable user. Write the summary in simple language. Transcript: [transcript text here]”

The server stores the summary information together with the audio file reference and the full character information. The server then generates alert notification information based on the evaluation result and the summary information. The alert notification information may include the risk level, the summary text, and time information. The server formats the alert notification information depending on an intended channel, such as an email format, a short text message, or a data packet for a push notification service. The server transmits the alert notification information to a pre-registered destination, such as a guardian device or a monitoring center, via the network interface.

The server also generates transmission status information that indicates whether each alert notification was successfully transmitted, failed, or is pending. The server sends the transmission status information to the terminal via a communication protocol such as a web-based application programming interface or a push notification system. The terminal receives the transmission status information, stores it in a local memory, and renders it on a display apparatus in a form understandable to the user, such as a dialog box or a notification banner. The user can thus confirm in real time that a suspicious call has been detected and that an alert has been sent.

The described configuration yields technical effects that go beyond mere automation of human judgment. By structuring the communication data as time-series character information and by using a sliding analysis window, the server reduces computational complexity and network bandwidth required for each interaction with the generative AI model, thereby improving processing speed and enabling near real-time detection during an ongoing call. By employing a neural network-based generative AI model with a transformer architecture, trained with domain-specific transcripts and explicit risk labels, the server achieves improved classification accuracy and robustness against evolving patterns of unlawful activity compared to fixed rule-based systems. The mapping of qualitative outputs to numerical scores and the use of threshold-based decision logic allow the system to operate as a deterministic state machine once the model output is obtained, which reduces ambiguity and facilitates integration with downstream modules such as recording and notification control.

Moreover, by dynamically generating prompt sentences that incorporate both recent transcript data and historical context, the server adapts the input to the generative AI model to each specific communication session. This dynamic prompt generation incorporates internal rules that are not obvious to a human operator, such as selecting only high-information phrases from the transcript or emphasizing particular linguistic features that have high predictive value in the trained model. As a result, the system improves computational efficiency, because less irrelevant text is processed, and improves detection precision, because the generative AI model receives context that is optimized for its learned representation space.

The system also provides alternative embodiments and variations. In one variation, the server executes the generative AI model on dedicated accelerator hardware such as a graphics processing unit or tensor processing unit, where the model weights are loaded into high-throughput memory, and attention operations are parallelized across multiple cores. In another variation, the server utilizes a hybrid model consisting of a rule-based pre-filter that identifies obvious benign patterns and a generative AI model that handles ambiguous or complex patterns, thereby further reducing average computation time. In yet another embodiment, the server adapts the predetermined time range length based on an observed speaking rate or detected topic boundaries, using unsupervised segmentation, to better capture semantically coherent segments, which leads to reduced misclassification rate.

The terminal can also be implemented in different forms, such as a mobile communication device, a personal computing device, or a specialized communication terminal. The terminal may perform partial preprocessing, such as encoding audio into a compressed streaming format, before transmission to the server, thereby reducing communication load. In some embodiments, the terminal may display, in addition to the transmission status information, simplified risk indications during the call, based on aggregated results received from the server at intervals.

The user interacts with the system mainly through the terminal's user interface. The user may register pre-registered destinations, set thresholds for alerting, and configure notification preferences. The user can review recorded communications and summaries after the fact, using a reviewing interface implemented by the terminal that retrieves stored information from the server.

Through these configurations, the server, the terminal, and the user together implement a technical solution in which digital audio is captured, encoded, transmitted, transformed into character information, analyzed using a structured interaction with a generative AI model via prompt sentences, and converted into concrete control actions on recording and notification modules. The described data structures, model architecture, training strategy, and decision logic improve computational performance, detection accuracy, and data management over conventional systems, and thereby provide a concrete improvement in computer technology applied to fraud detection in communication systems.

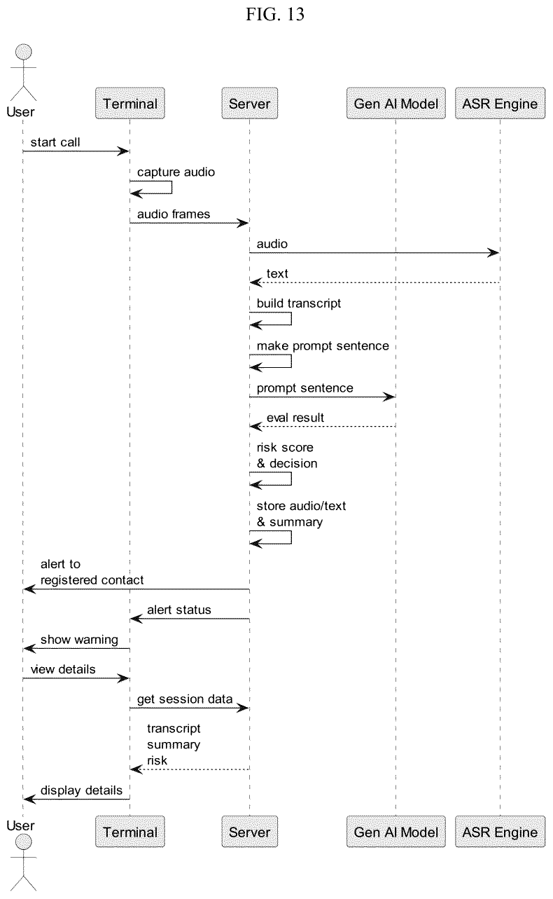

The following describes the processing flow using FIG. 13.

### Step 1:

The terminal detects that a communication session has started.

The terminal uses an operating system call API and an audio input API to monitor call state transitions and to activate a microphone path.
Input: a call state change event from the operating system.

Output: an activated audio capture pipeline ready to acquire audio samples.

The terminal converts analog voice signals from the microphone into digital audio samples using an audio codec, and stores the samples into a ring buffer in a terminal memory.

### Step 2:

The terminal segments the captured audio samples into fixed-length frames.
Input: a continuous stream of raw digital audio samples from the ring buffer.
Output: a sequence of audio frames, each having a predefined duration and size.

The terminal copies a contiguous block of samples from the ring buffer into a frame buffer, tags the frame with a timestamp and a session identifier, and enqueues the frame into a transmission queue in the terminal memory.

### Step 3:

The terminal transmits the audio frames to the server over a network.
Input: the queued audio frames with associated metadata (session identifier, user identifier, timestamps).
Output: network packets containing the audio frames and metadata delivered to the server.

The terminal opens or maintains a secure connection using a transport layer security protocol, serializes each audio frame into a request message, and sends the request through a network interface. If the terminal detects a temporary network failure, the terminal retries the transmission and caches unsent frames in local storage.

### Step 4:

The server receives the audio frames from the terminal.
Input: encrypted network packets that carry audio frames and metadata.
Output: validated audio frame objects stored in a time-indexed buffer in a server memory.

The server terminates the secure connection, validates authentication tokens and packet integrity, parses the request messages to extract the audio payload and metadata, and inserts each frame into a per-session buffer or queue indexed by time.

### Step 5:

The server normalizes the audio format of the received frames.
Input: raw audio frames that may have various sample rates, channel counts, or encodings.
Output: normalized audio frames in a uniform format suitable for speech recognition.

The server checks header information and, when necessary, uses an audio processing library to resample, downmix to a single channel, and convert the encoding to a standardized linear pulse code modulation format at a predetermined sample rate, then stores the normalized frames back into a buffer for further processing.

### Step 6:

The server performs speech recognition to convert audio frames into character information segments.
Input: normalized audio frames associated with session identifiers and timestamps.
Output: character information segments, each with associated start time, end time, and session identifier.

The server sends batches of audio frames to a speech recognition engine, receives decoded text strings for each batch, and assembles those strings into discrete character segments, attaching time information and confidence scores before writing them into a database.

### Step 7:

The server aggregates the character information segments into a time-series transcript for each session.
Input: newly generated character information segments with timestamps.
Output: an updated aggregated character information structure representing the communication session transcript.

The server locates the existing transcript structure for the session, appends the new segments in chronological order, merges adjacent segments if necessary, and updates indices that map time points to character positions to allow efficient subsequent retrieval.

### Step 8:

The server extracts analysis target character information corresponding to a predetermined time range.
Input: the aggregated time-series transcript and a definition of a sliding time window.
Output: a contiguous character string representing analysis target character information for the recent portion of the session.

The server computes the window start time based on the current time and the configured window length, selects all segments whose timestamps fall within the window, concatenates the text fields in chronological order, and annotates the concatenated text with markers if speaker labels or entity information are available.

### Step 9:

The server constructs a prompt sentence for a generative AI model.
Input: the analysis target character information and stored evaluation conditions for unlawful activity detection.
Output: a complete prompt sentence in natural language ready to be supplied to the generative AI model.

The server loads a prompt template from memory, replaces placeholders in the template with the extracted text and context information such as prior risk history, and embeds explicit instructions regarding risk labels, output format, and factors to consider. The server generates a plain text string by assembling instruction text and the analysis target character information.

### Step 10:

The server sends the prompt sentence to the generative AI model and obtains an evaluation result.
Input: the constructed prompt sentence and configuration parameters for the model (for example, maximum output length, decoding strategy).
Output: a textual evaluation result that describes a risk label and an explanation.

The server tokenizes the prompt sentence and forwards it to a generative AI model implemented as a neural network, waits for the model to produce output tokens, reconstructs the output text from tokens, and logs both the input prompt and the output text for traceability.

### Step 11:

The server converts the textual evaluation result into a numerical risk score.
Input: the evaluation result containing a qualitative risk label, such as “HIGH”, “MEDIUM”, or “LOW”, and an optional explanation.
Output: a numerical risk score associated with the communication session.

The server parses the evaluation result string, extracts the category label, maps the label to a numeric value using a predetermined mapping table, and stores this numeric value together with the explanation text in the session record in the database.

### Step 12:

The server compares the numerical risk score with a threshold and determines whether to classify the session as suspicious.
Input: the numerical risk score and a configuration parameter representing a threshold value.
Output: a decision flag indicating whether the session is classified as having a high possibility of unlawful activity.

The server performs a comparison operation between the risk score and the threshold value, sets a binary or multi-level decision flag accordingly, and writes this decision flag into the session state, which controls subsequent recording and notification actions.

### Step 13:

The server records and stores session audio and character information when the decision flag indicates a high possibility of unlawful activity.
Input: the decision flag indicating a suspicious session, and the buffered audio information and aggregated character information for the session.
Output: stored audio data, stored text data, and associated metadata entries in a persistent storage.

The server serializes the audio buffer into a file or object, optionally compresses the data using an audio compression algorithm, writes the resulting data to a storage apparatus, and records a reference path. The server also commits the full transcript and metadata such as timestamps and risk scores into a database table or document.

### Step 14:

The server generates summary information for the suspicious communication session.
Input: the full character information for the session and the decision flag indicating that summarization is required.
Output: a summary text that concisely describes the communication session with emphasis on suspicious parts.

The server constructs a summarization prompt sentence that includes instructions to focus on indications of unlawful activity and appends the full transcript as context. The server provides this prompt sentence to the generative AI model, obtains a summary text, and stores the summary text with the session record.

### Step 15:

The server composes alert notification information based on the evaluation result and the summary information.
Input: the numerical risk score, the qualitative risk label, the explanation text from the evaluation result, the summary text, and session metadata such as start time and caller information.
Output: a structured alert notification payload suitable for transmission to pre-registered destinations.

The server arranges these elements into a message structure, formats the text according to the requirements of different communication channels, and adds identifiers that link back to the stored session data.

### Step 16:

The server transmits the alert notification information to pre-registered destinations.
Input: the composed alert notification payload and a list of destinations obtained from configuration data.
Output: outgoing alert messages sent over various communication channels and status responses for each transmission attempt.

The server iterates over the list of destinations, selects an appropriate delivery method for each destination, sends the notification via network protocols specific to the method, and collects acknowledgments or error messages that indicate transmission success or failure.

### Step 17:

The server generates transmission status information for the alert notifications.
Input: the individual transmission results including success flags, error codes, and timestamps.
Output: summarized transmission status information for the session.

The server aggregates the per-destination results into a status object that states whether at least one alert was successfully delivered and includes details of failures, then stores this status object in the database and prepares it in a format consumable by the terminal.

### Step 18:

The terminal obtains the transmission status information from the server.
Input: a status request initiated automatically or by user interaction, and the transmission status information provided by the server in response.
Output: local status data indicating the current state of alert notifications for the communication session.

The terminal sends a query to the server's status endpoint, receives a structured response with fields describing success or failure of each alert, parses the response, and updates an internal representation of the notification state.

### Step 19:

The terminal displays the transmission status information to the user.
Input: the parsed transmission status information indicating risk level, alert delivery state, and optionally a short warning message.
Output: a visual or audible indication on the terminal that informs the user about the detection result and the alert status.

The terminal renders the information on a display apparatus as text, icons, or dialog boxes, and may also play a sound or vibration pattern. The user thus perceives that a possible unlawful activity has been detected and that designated contacts have been informed.

### Step 20:

The user reviews detailed information about the suspicious communication session.
Input: a user command selecting a particular session and the stored session data retrieved from the server, including transcript, summary, risk score, and alert history.
Output: a presentation of detailed session information on the terminal.

The terminal sends a retrieval request to the server, receives the session details, and displays the character information, the summary text, and the risk level so that the user can understand the nature of the detected unlawful activity and take further action if needed.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional fraud-detection systems that analyze communication content (such as call transcripts, text messages, or emails) typically rely on fixed keyword lists, static rule sets, or single-purpose classification models. Such systems suffer from several technical limitations at the computing level.
First, conventional systems are often architected as linear pipelines in which speech recognition, text analysis, and alerting are weakly coupled. A processor that only applies rigid pattern matching to text data, without context-sensitive reasoning, tends to generate a large number of false positives and false negatives. This degrades system reliability and requires frequent manual tuning of rules, thereby increasing computational overhead and maintenance cost.
Second, known systems generally treat emotion-related signals (for example, changes in voice tone or sentiment in text) as peripheral information, or ignore them entirely. As a result, the processor cannot adjust its fraud-risk estimation based on the emotional state of the user, even though such signals are often strongly correlated with coercive or deceptive interactions. The inability to algorithmically integrate emotion information into the risk computation leads to suboptimal utilization of available sensor data and underperforms in high-risk communication scenarios.
Third, existing architectures typically invoke generative artificial intelligence models, if at all, in an ad hoc fashion. They do not structure input to such models as formally defined prompt sentences that encode machine-extracted features, emotion data, and context, nor do they systematically integrate the output of generative models with conventional pattern-recognition and machine-learning results. Consequently, the processor either cannot make full use of the contextual reasoning capabilities of generative models, or must rely solely on those models in a non-deterministic way, which raises issues in latency, reproducibility, and controllability of system behavior.
Fourth, conventional systems lack a unified mechanism in the processor to compute an overall risk level by algorithmically combining: (i) feature information extracted from text; (ii) evaluation results from a generative artificial intelligence model; and (iii) evaluation results from emotion estimation processing. Without such a unified mechanism, the processor cannot deterministically map heterogeneous analysis outputs to consistent control decisions for recording, notification, and warning operations. This leads to inefficient use of computational resources, inconsistent user protection, and difficulty in verifying or auditing system decisions.

Accordingly, there is a need for an improved computer-implemented system and processor configuration that can: (1) convert audio information into character information; (2) automatically extract feature information indicative of fraudulent activity from communication information and associated emotion information; (3) generate structured prompt sentences as evaluation target information for a generative artificial intelligence model; (4) integrate the model's evaluation result with machine-derived feature information and emotion information; and (5) compute a unified, overall fraud-risk level that directly drives recording, notification, and warning operations. By solving these technical problems within the processor architecture itself, the present invention aims to improve the accuracy, robustness, and controllability of computer-based fraud detection and user protection in real-time communication environments.

The specific processing by the specific processing unit 290 of the data processing device 12 in Application Example 2 is realized by the following means.

The present invention provides a server comprising a processor configured to acquire communication information including audio information from one or more communication devices, convert the audio information included in the communication information into character information, extract feature information indicating a possibility of fraudulent activity based on the character information and emotion information associated with the character information, generate a prompt sentence as evaluation target information including at least the feature information to cause a generative information processing model to evaluate the possibility of the fraudulent activity, input the prompt sentence into the generative information processing model and obtain an evaluation result regarding the possibility of the fraudulent activity from the generative information processing model, calculate an overall risk level of the fraudulent activity by integrating the evaluation result, the feature information, and an evaluation result of emotion estimation processing performed on at least one of the audio information and the character information, and control predetermined operations including at least one of recording processing, notification processing, and warning processing in accordance with the overall risk level. This enables the server to implement an improved computer-based fraud-detection pipeline in which heterogeneous analysis components are orchestrated within the processor: audio is reliably transformed into character information; feature information and emotion information are fused into structured prompt sentences for the generative information processing model; the model's contextual evaluation is algorithmically combined with pattern-recognition and machine-learning results; and the resulting unified risk level deterministically drives system actions, thereby improving detection accuracy, reducing false positives and false negatives, and providing timely, consistent protection of users in real-time communication environments.
The term “communication information” refers to information representing at least one communication session, including audio information such as voice signals from a call and optional associated data such as timestamps, identifiers, and protocol-level metadata.
The term “audio information” refers to information representing sound, including but not limited to digitized voice signals captured during a communication session and stored or processed as time-series data.
The term “character information” refers to information representing text obtained by converting audio information into a textual form, and may include normalized or preprocessed text suitable for further analysis.
The term “emotion information” refers to information indicating an estimated emotional state associated with a user, the communication information, or the character information, and may include one or more emotion labels and corresponding confidence values or scores.
The term “feature information” refers to information including one or more feature values or feature vectors extracted from the communication information, the character information, and the emotion information, the feature values or feature vectors being indicative of a possibility of fraudulent activity.
The term “evaluation target information” refers to information provided as input to a generative information processing model, including at least the feature information and optionally the character information and the emotion information, and being structured so as to enable the model to perform an evaluation of a possibility of fraudulent activity.
The term “prompt sentence” refers to a sequence of characters forming an instruction, query, or context that is input to a generative information processing model to cause the model to execute an evaluation, generation, or other processing regarding the possibility of fraudulent activity.
The term “generative information processing model” refers to an information processing model implemented by hardware and software that is trained using machine learning to generate or transform information, and that is capable of receiving a prompt sentence and outputting an evaluation result or other generated information based on the prompt sentence.
The term “evaluation result” refers to information output from the generative information processing model or other analysis components, indicating at least a degree or score of the possibility of fraudulent activity and optionally including explanatory or reasoning information.
The term “overall risk level” refers to a value or classification representing a comprehensive degree of the possibility of fraudulent activity, obtained by integrating at least the evaluation result from the generative information processing model, the feature information, and an evaluation result of emotion estimation processing.
The term “recording processing” refers to processing in which information related to a communication session, including at least one of audio information, character information, or metadata, is stored or caused to be stored in a storage apparatus in association with the overall risk level.
The term “notification processing” refers to processing in which information indicating at least part of the evaluation result or the overall risk level is transmitted or caused to be transmitted to one or more external devices or destinations, such as terminals or management systems.
The term “warning processing” refers to processing in which information indicating a warning about a possibility of fraudulent activity is presented or caused to be presented to a user or another party, for example by display, sound output, or message transmission.
The term “pattern recognition processing” refers to information processing that detects patterns, such as specific terms, expressions, or structural relations, from the character information or other data, using at least one of rule-based techniques and statistical or learning-based techniques.
The term “machine learning processing” refers to information processing that uses a model trained on training data to output a prediction or classification, such as a fraud probability score, based on input data including at least the character information or the feature information.
The term “emotion estimation processing” refers to processing that inputs at least one of audio information and character information and outputs the emotion information, including at least one estimated emotion label and an associated degree or confidence.
The term “predetermined operations” refers to one or more operations that are defined in advance and are executed or controlled by the processor based on the overall risk level, the predetermined operations including at least one of recording processing, notification processing, and warning processing.

In one embodiment, a server cooperates with one or more terminals operated by users to implement the system defined in the claims. The server includes at least one processor, a memory, a network interface, and a non-transitory computer-readable storage medium. The terminal includes at least one processor, a microphone, a display, an audio output unit, and a wireless communication interface. The server and the terminal execute computer programs stored in their respective storage media to perform the functions described below.

The terminal acquires communication information including audio information. The terminal operates as a mobile communication device such as a smartphone or tablet, and uses an operating system-level telephony interface and messaging interface to obtain audio streams and text messages. The terminal captures audio information from voice calls via a built-in microphone and baseband subsystem as a digital audio stream, for example, as linear PCM data at a sampling rate such as 8 kHz or 16 kHz. The terminal also acquires message text from short message services, electronic mail clients, and messenger applications through application-level interfaces or accessibility frameworks. The terminal stores the acquired communication information in a structured data format in local memory. For example, the terminal may store a record including fields such as a communication identifier, a time stamp, a channel type, a remote party identifier, a pointer to an audio buffer, and a text field.

The terminal converts the audio information into character information. The terminal uses a speech recognition component that may be implemented as a local model or as an external service. As examples of external services, the terminal may use a generic cloud speech recognition service provided by a remote computing platform, via an HTTP-based application programming interface. As an example of a local model, the terminal may execute an acoustic model and a language model implemented using a neural network framework on the terminal hardware. In such a configuration, the terminal transforms the time-domain audio stream into a sequence of feature vectors, for example mel-frequency cepstral coefficients or log mel spectrograms, and inputs the feature vectors to a deep neural network such as a connectionist temporal classification model. The terminal decodes the output probabilities into a character sequence using a beam search algorithm and a lexical constraint. The terminal normalizes the character sequence by converting characters to a standard case, removing filler expressions, and standardizing numerals and currency symbols, thereby generating character information suitable for subsequent analysis.

The server and the terminal extract feature information indicating a possibility of fraudulent activity. The terminal initially executes natural language processing on the character information using a software library such as a general-purpose tokenization and part-of-speech tagging engine. The terminal detects candidate tokens, entities, and patterns, including references to money, financial accounts, transfers, time limits, and kinship relations. The terminal forms feature vectors including, for example, token frequency counts, presence or absence of specific expressions, syntactic dependency patterns, and numeric values extracted from the character information.

The terminal then optionally applies a machine learning classifier to the feature vectors as a first-stage filter. The classifier may be a neural network such as a feed-forward network with one or more hidden layers using a rectified linear unit activation function, or a gradient-boosted decision tree model trained on labeled examples of fraudulent and non-fraudulent communication. The terminal stores the classifier output as a preliminary fraud score and adds this score to the feature information.

The terminal and the server obtain emotion information associated with the character information. The terminal uses an emotion estimation component that analyzes the acoustic characteristics of the user's voice, including fundamental frequency, spectral tilt, energy distribution, and temporal dynamics. The terminal computes, for example, a set of prosodic features over sliding windows and inputs those features into a neural network trained to output emotion probabilities, such as calm, fear, anger, and confusion. Alternatively or additionally, the server analyzes the character information using a sentiment analysis model implemented as a recurrent neural network or a transformer neural network. The server maps sentence-level embeddings to emotion labels using a softmax output layer and generates emotion scores. The terminal and the server together store the emotion information along with the communication identifier and the character information.

The server generates a prompt sentence as evaluation target information including at least the feature information and the emotion information. The server maintains a template repository in its memory. Each template is a text pattern that includes placeholders for the character information, the feature information, and the emotion information. The processor on the server selects an appropriate template according to a communication type and risk level. For example, the server may generate a prompt sentence such as:
“Analyze the following communication received by an elderly user and evaluate the likelihood of special fraud. Provide a risk score between 0.0 and 1.0 and explain your reasoning. Text: ‘[character information]’. Extracted indicators: [feature information]. User emotion state: [emotion information]. Output JSON fields: risk_score, reasoning, recommended_actions.”

In another example, when the communication is a telephone call including urgent transfer requests, the server may generate a prompt sentence such as:
“This call transcript involves a request for money transfer and a claim of an emergency. Evaluate whether this is likely to be a fraud targeting an elderly person. Consider the following text and detected keywords. Text: ‘[character information]’. Keywords: money, transfer, account, emergency. User emotion: high fear, high confusion. Provide a numerical fraud risk and a short explanation.”

The server inputs the prompt sentence into a generative information processing model. In one embodiment, the generative information processing model is a language model implemented as a multi-layer transformer neural network. The model includes an embedding layer that transforms tokens of the prompt sentence into dense vectors, a plurality of self-attention layers that compute contextual representations, and an output layer that generates token probabilities. The model is pre-trained on large-scale text corpora and further fine-tuned on task-specific data including annotations for fraud risk and explanation. The server uses an application programming interface to send the prompt sentence to the model engine, receives the generated output tokens, and decodes them into a structured response.

The server obtains an evaluation result from the generative information processing model. The server parses the generated text, for example by recognizing a “risk_score” field, a “reasoning” field, and a “recommended_actions” field. If the model outputs free-form natural language, the server applies a rule-based parser or a secondary classifier to extract a normalized risk score. The server combines this risk score with the feature information and the emotion information. For example, the server computes an overall risk level using a formula that weights the generative model risk score, the first-stage classifier score, and an emotion-based factor that increases when fear or confusion scores are high. The server may implement this computation as a logistic regression model or as a small neural network trained to output a calibrated probability of fraudulent activity.

The server controls predetermined operations in accordance with the overall risk level. The server stores communication records, including audio information, character information, feature information, emotion information, and evaluation results, in a structured database. When the overall risk level satisfies a threshold, the server may initiate recording processing by instructing the terminal to upload call audio segments or by extending retention periods in storage. The server may execute notification processing by sending an electronic message through a communication gateway to a caregiver device, indicating that a suspicious communication has been detected and including a summary of the evaluation result. The server may execute warning processing by transmitting a control message to the terminal, which displays a warning dialog on its display and may output an audio alert via the terminal's speaker.

The terminal presents the warning and receives user input. For example, the terminal may display a message such as:
“This communication may be a special fraud attempt. Do you want to end the call and notify your emergency contact?”

The user may select an action such as terminating the ongoing call, confirming or dismissing the warning, or authorizing additional notifications. The server records the user's response and may use this feedback as labeled data in a retraining process for the models.

The server improves computer-implemented fraud detection beyond a mere automation of human review. The system uses specific data structures, including multi-field records linking audio information, character information, feature information, emotion information, and evaluation results. The server employs multi-stage processing that integrates pattern recognition, machine learning, and generative inference into a single controlled pipeline. By passing structured feature information and emotion information into the generative information processing model via a prompt sentence, the server constrains the model's operation and reduces unnecessary computation. The integration of multiple sources of evidence into an overall risk level enables the server to maintain a stable false positive and false negative rate while operating in real time across many concurrent communication sessions.

The generative information processing model operates according to an architecture that is distinct from simple rule systems. The model parameters are learned using gradient-based optimization on training data including fraudulent and non-fraudulent communication texts. A loss function, such as cross-entropy between predicted risk classes and ground-truth labels, is minimized by adjusting weights in the attention layers and feed-forward layers. The training may employ mini-batch stochastic gradient descent with adaptive learning rate, dropout regularization, and data augmentation such as paraphrasing or noise injection in training texts. By disclosing specific processing of the prompt sentence, the feature information, and the model output, the system's internal operation is technically concrete and reproducible.

The system achieves several technical effects. First, the server reduces network load and processing latency by performing first-stage filtering on the terminal and sending only summarized feature information and necessary character information to the server. Second, the server improves detection accuracy and stability by combining pattern-based scoring, model-based scoring, and emotion-based scoring in a defined computation, instead of relying on a single heuristic or unstructured model output. Third, the server enhances data management by organizing communication information and analysis results into indexed records that permit efficient retrieval, correlation of multiple events, and auditability. Fourth, the coordinated control of recording, notification, and warning processing reduces unnecessary storage and spurious alerts, while focusing resources on high-risk communications.

In an alternative embodiment, the server may host the speech recognition component and the emotion estimation component. In this case, the terminal transmits raw or compressed audio information to the server, and the server performs feature extraction and character conversion in a centralized processing environment. This configuration may be suitable for terminals with limited computation resources. In another variation, the generative information processing model may be deployed on a dedicated accelerator node, and the server may communicate with this node through a high-speed interconnect. The server may also select among multiple generative models or prompt templates based on language, user profile, or regulatory region.

In yet another embodiment, the system may apply different weighting schemes or thresholds based on historical behavior recorded in the database. The server can adapt the risk computation to specific users, terminals, or communication patterns by updating model parameters or rules using feedback on confirmed fraudulent or benign events. The server may perform periodic retraining of the neural networks using accumulated data, using supervised learning with manually or semi-automatically labeled samples.

By implementing these configurations, the server and the terminal collectively realize a technical solution in which the conversion of audio information to character information, the extraction of feature and emotion information, the generation of structured prompt sentences, and the integration of generative and discriminative model outputs are executed as a unified computer-implemented process. This process is tied to physical communication devices, controls storage and notification hardware, and improves the operation of the computing system itself in terms of detection accuracy, computation efficiency, and communication resource utilization, rather than merely automating a mental evaluation task.

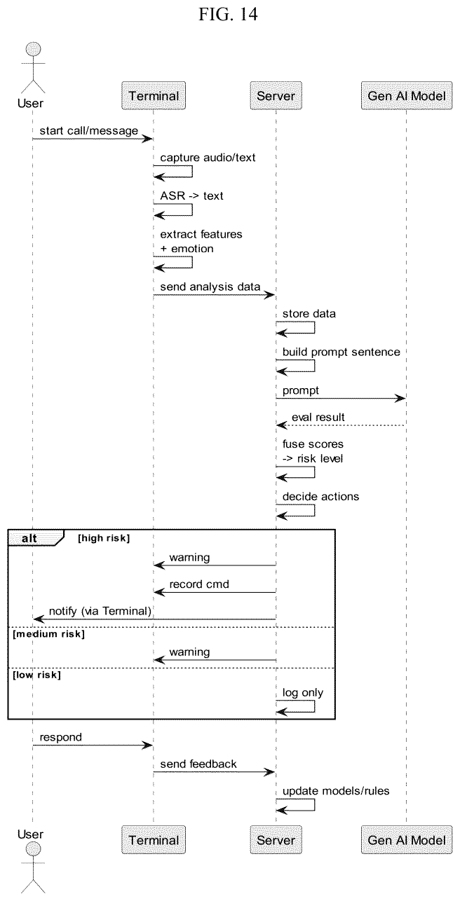

The following describes the processing flow using FIG. 14.

### Step 1:

The terminal acquires communication information including audio information.

The terminal receives as input a communication event from an operating system interface, such as an incoming or outgoing voice call, a text message, or a messenger application message.

The terminal reads audio information from the microphone and telephony subsystem for voice calls and reads text content from messaging interfaces for text-based communications.

The terminal performs data processing by encapsulating the raw audio stream and text content into a structured record that includes fields such as communication ID, timestamps, remote party identifier, channel type, and pointers to buffers.

The terminal outputs a stored communication record in a local memory or storage unit, which serves as the basis for subsequent conversion and analysis.

### Step 2:

The terminal converts audio information into character information.

The terminal receives as input the audio information associated with a communication record from Step 1.

The terminal segments the audio stream into frames, computes acoustic features such as mel-frequency cepstral coefficients or log mel spectrograms, and feeds these features to a speech recognition engine.

The terminal uses either an embedded neural network model or a cloud-based speech recognition service to generate text hypotheses and performs decoding, such as beam search, to determine the most probable text sequence.

The terminal normalizes the recognized text by applying case normalization, punctuation cleanup, and standardization of number and currency formats.

The terminal outputs character information, which is stored in association with the original communication record.

### Step 3:

The terminal performs first-stage linguistic feature extraction.

The terminal receives as input the character information from Step 2 or directly received text from messaging services.

The terminal tokenizes the text into words or subwords, determines part-of-speech tags, and detects named entities such as person names, financial institutions, and monetary amounts.

The terminal computes feature values including counts of risk-related words (for example, money, account, transfer, emergency), presence of specific phrase patterns (for example, “transfer immediately,” “verify account”), and extracted numeric amounts.

The terminal aggregates these values into a feature vector with predefined positions representing specific linguistic indicators.

The terminal outputs a linguistic feature vector linked to the communication record.

### Step 4:

The terminal estimates a preliminary fraud score using a machine learning classifier.

The terminal receives as input the linguistic feature vector from Step 3.

The terminal passes the feature vector to a trained classifier model such as a neural network or gradient-boosted decision tree model stored in the terminal memory.

The terminal performs numerical computations including matrix multiplications, activation function applications, and probability normalization to obtain a scalar output indicating the likelihood of fraudulent activity.

The terminal compares the scalar output with one or more thresholds to derive a preliminary classification such as low, medium, or high suspicion.

The terminal outputs the preliminary fraud score and classification and attaches them to the communication record as part of feature information.

### Step 5:

The terminal derives emotion information from audio and/or text.

The terminal receives as input the audio information and the character information associated with the communication record.

The terminal computes prosodic features from the audio, including pitch contours, intensity, speaking rate, and spectral characteristics, and forms an acoustic feature vector.

The terminal inputs the acoustic feature vector into an emotion estimation model that outputs probabilities for emotion categories such as calm, fear, anger, and confusion.

Alternatively or additionally, the server analyzes the character information using a text-based emotion or sentiment model and returns emotion scores to the terminal.

The terminal aggregates these scores over the duration of the communication and constructs emotion information including labels and confidence values.

The terminal outputs emotion information and updates the communication record accordingly.

### Step 6:

The terminal packages analysis information and sends it to the server.

The terminal receives as input the communication record containing character information, the linguistic feature vector, the preliminary fraud score, and the emotion information from Steps 2-5.

The terminal constructs a data object, for example a structured message including fields for text, feature values, emotion scores, timestamps, and identifiers.

The terminal performs data serialization into a network format such as JSON and encrypts the payload using a secure transport protocol.

The terminal transmits the serialized data to the server via a network interface, handling retries and acknowledgments as necessary.

The terminal outputs a transmitted analysis request available to the server for further processing.

### Step 7:

The server receives and stores the analysis request.

The server receives as input the serialized analysis request from the terminal over a network connection.

The server authenticates the terminal, validates mandatory fields, and deserializes the received payload into internal data structures.

The server writes the deserialized data into a storage system, such as a relational or document database, assigning an internal analysis ID to the event.

The server may add system metadata such as processing time, terminal profile, and model version identifiers.

The server outputs a stored analysis record ready for advanced evaluation.

### Step 8:

The server generates a prompt sentence for a generative AI model.

The server receives as input the analysis record, including character information, feature information, and emotion information from Step 7.

The server selects a prompt template based on parameters such as language, channel type, and preliminary fraud score.

The server substitutes actual text, feature values, and emotion summaries into placeholder positions in the template, performing string concatenation and formatting to produce a coherent instruction.

The server creates a prompt sentence such as:
“Analyze the following communication received by an elderly user and evaluate the likelihood of special fraud. Provide a risk score between 0.0 and 1.0 and explain your reasoning. Text: ‘[character information]’. Extracted indicators: [feature information]. User emotion state: [emotion information]. Output JSON fields: risk_score, reasoning, recommended_actions.”

The server outputs the completed prompt sentence as evaluation target information for the generative AI model.

### Step 9:

The server obtains an evaluation result from the generative AI model.

The server receives as input the prompt sentence from Step 8.

The server sends the prompt sentence to a generative AI model implementation through an application programming interface and waits for the model output.

The server receives text generated by the model, which may contain a numerical risk score, explanatory text, and recommended actions.

The server parses the output by applying rule-based parsing or lightweight natural language processing to extract a machine-readable risk score and structured reasoning.

The server outputs an evaluation result including at least a normalized risk score and associated explanation.

### Step 10:

The server computes an overall risk level by integrating multiple evaluation sources.

The server receives as input the evaluation result from Step 9, the preliminary fraud score and classification from Step 4, and the emotion information from Step 5.

The server constructs a combined feature vector that includes numerical values for the generative model risk score, the preliminary fraud score, and emotion indicators such as fear and confusion scores.

The server applies a combining function, for example a weighted sum or a small trained model, to calculate a single scalar value representing the overall risk of fraudulent activity.

The server compares this scalar value against preconfigured thresholds to determine a discrete risk level such as low, medium, or high.

The server outputs the overall risk level and stores it in association with the analysis record.

### Step 11:

The server determines and initiates predetermined operations based on the overall risk level.

The server receives as input the overall risk level from Step 10 and the associated analysis record.

The server consults a control rule set that maps risk levels to operational actions, such as recording extension, notification to external contacts, or local warning generation on the terminal.

The server selects the applicable actions and generates corresponding control commands or messages, which may include parameters such as communication ID, time window, and summary of the detected risk.

The server outputs action instructions directed to storage systems, notification services, and the terminal.

### Step 12:

The server performs recording processing.

The server receives as input an action instruction indicating that recording processing is required.

The server checks whether the audio information for the communication is already stored or must be retrieved from the terminal.

If retrieval is required, the server sends a request to the terminal to upload audio segments corresponding to the high-risk communication.

The server stores the uploaded audio and associated metadata in a storage service with an appropriate retention policy based on the risk level.

The server outputs a record of stored evidence that can be referenced in later investigations or audits.

### Step 13:

The server performs notification processing.

The server receives as input an action instruction indicating that notification processing is required and the overall risk level.

The server generates a human-readable summary of the communication and the evaluation result, optionally using an additional summarization prompt sentence sent to the generative AI model.

The server composes a notification message including fields such as recipient contact information, short description of the suspicious content, and recommended next steps.

The server sends the notification through a communication gateway, such as an email server or a text message service, to designated contacts such as caregivers or family members.

The server outputs a delivered notification log for future reference.

### Step 14:

The server performs warning processing directed to the terminal.

The server receives as input an action instruction that a warning should be displayed to the user.

The server constructs a warning payload including the overall risk level, a brief explanation, and suggested user actions, and transmits this payload to the terminal via a secure communication channel.

The terminal receives the warning payload, interprets the contents, and triggers a user interface event on the display, such as a pop-up dialog warning the user about potential fraud.

The terminal may also generate an audio alert via a speaker to attract the user's attention.

The terminal outputs a visible and/or audible warning to the user.

### Step 15:

The user responds to the warning and the terminal records the response.

The user receives as input the warning displayed on the terminal and any accompanying audio signal.

The user selects one of several options presented on the terminal, such as ending the ongoing call, notifying a trusted contact, or dismissing the warning as a false alarm.

The terminal captures the user's selection and encodes it as a response event associated with the communication record.

The terminal transmits this response event to the server, which stores it as feedback for later analysis or model retraining.

The terminal and the server output an updated record that reflects both the system's evaluation and the user's actual decision.

### Step 16:

The server optionally refines models and rules using accumulated feedback.

The server receives as input stored feedback events indicating whether communications classified as suspicious were later confirmed as fraudulent or benign.

The server aggregates these events into datasets for retraining the preliminary classifier, adjusting combination weights for overall risk computation, and refining prompt templates.

The server executes training processes that minimize an error function, such as misclassification rate or cross-entropy, by updating model parameters and, if necessary, revising threshold values and rule conditions.

The server deploys updated model parameters and configuration data to terminals in the field, thereby aligning on-device preliminary assessments with the latest understanding of fraud patterns.

The server outputs improved models and configuration data that enhance future detection and control actions.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

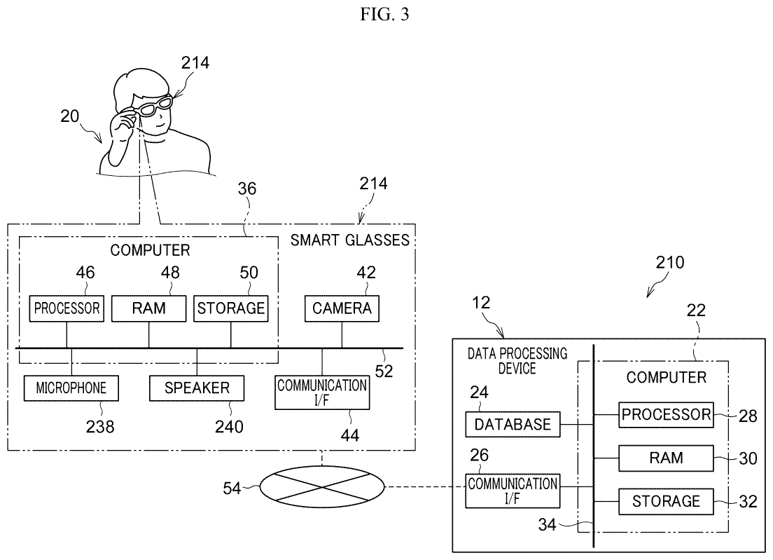

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

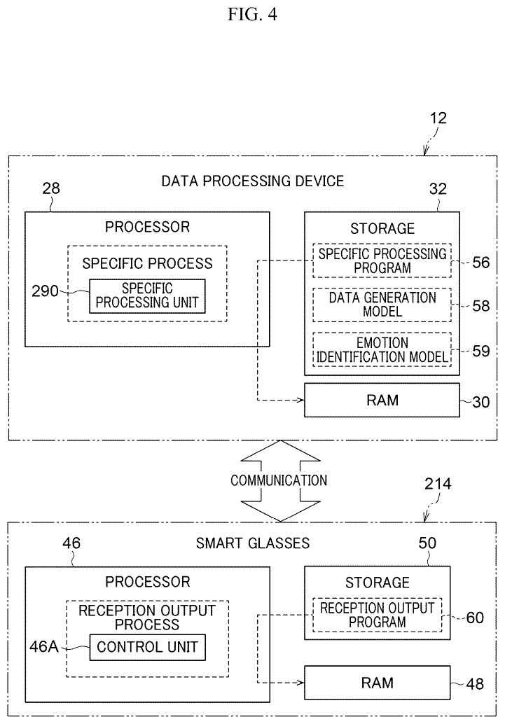

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

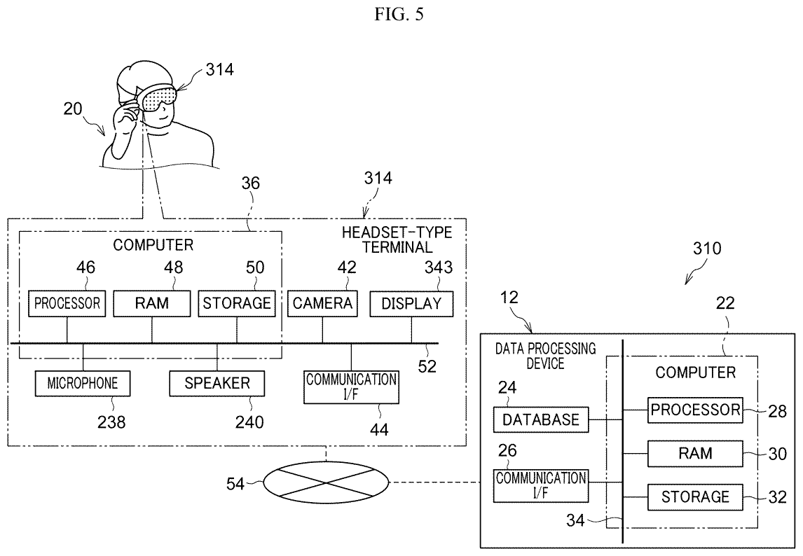

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

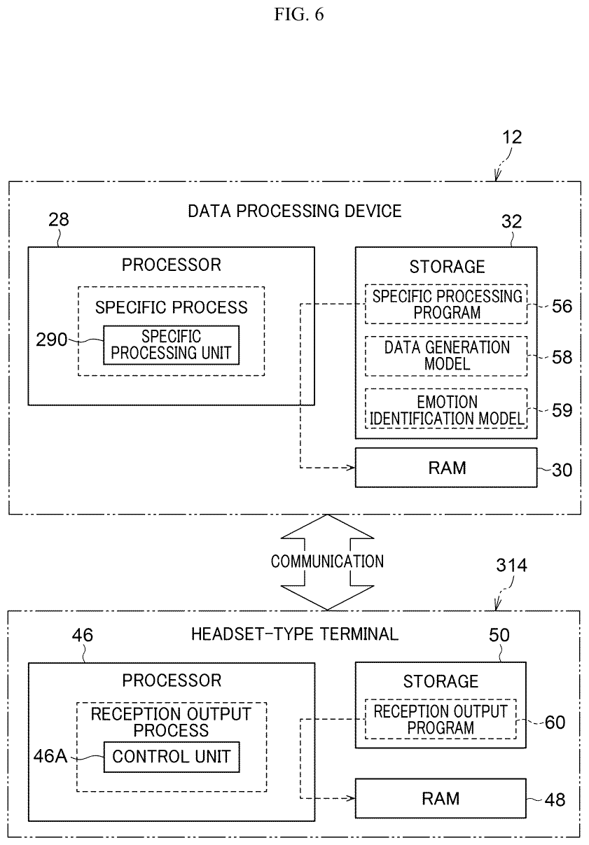

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

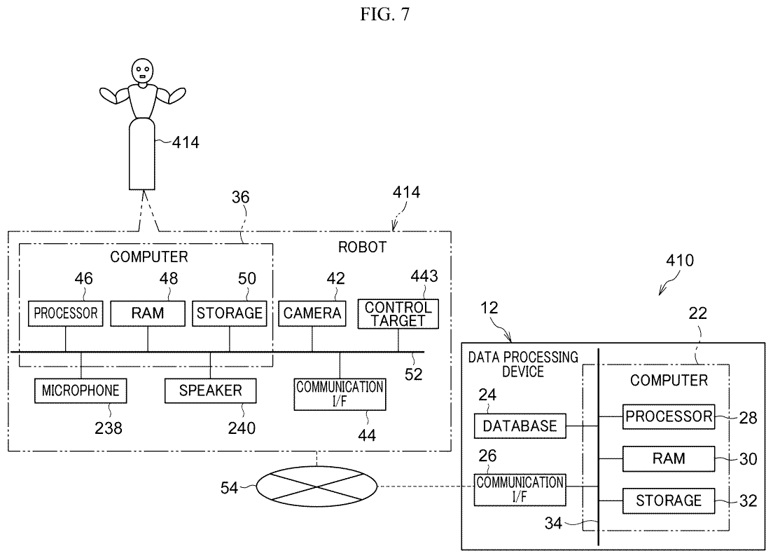

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

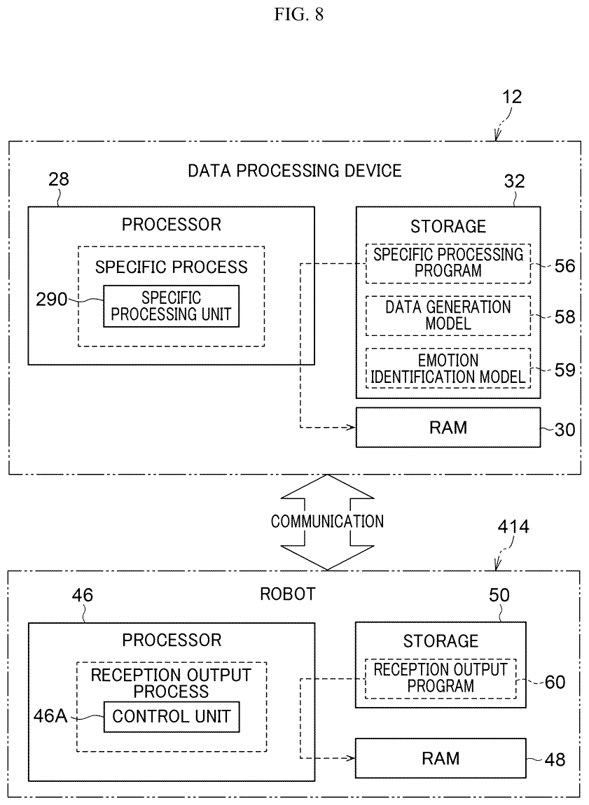

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

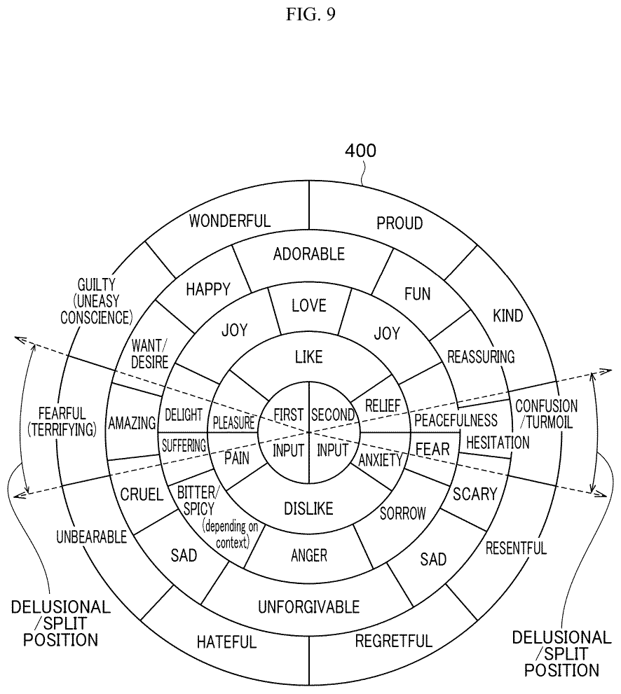

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

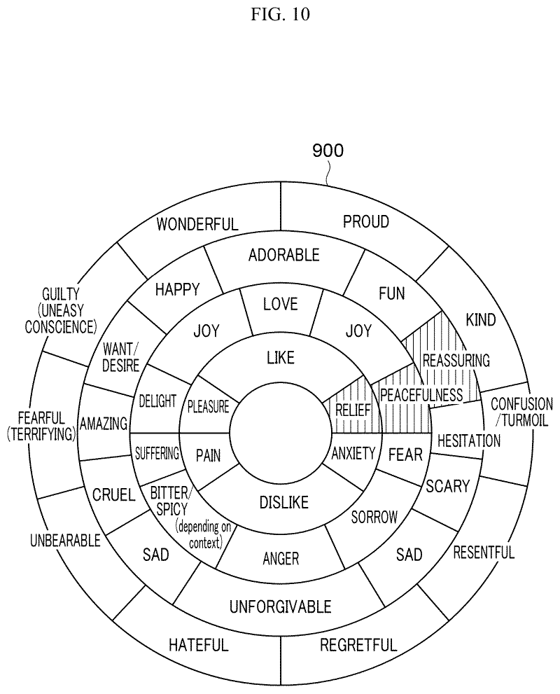

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
monitor communications of a user to acquire audio information and character information, convert the acquired audio information into character information, and perform preprocessing by associating the character information with additional information including communication time information and caller identification information,
generate a prompt sentence based on the preprocessed character information and the additional information, the prompt sentence instructing evaluation of a possibility of fraudulent activity and embedding the character information and definition information of the fraudulent activity so as to specify an output format and evaluation criteria for a generative AI model,
input the prompt sentence into the generative AI model to obtain an evaluation result relating to the fraudulent activity, and determine a risk level of the fraudulent activity by comparing a numerical risk index included in the evaluation result with a predetermined threshold,
output, when the risk level satisfies a predetermined condition, a control signal to a terminal or an external device so as to cause execution of at least one operation selected from an operation of storing a call record or a communication record in a storage device, an operation of displaying warning information on the terminal, and an operation of transmitting notification information to a pre-registered contact, and
receive, from the terminal via a secure communication path, the preprocessed character information and the additional information, and store the evaluation result and the control signal in association with each other in a recording device.

### Supplementary 2

The system according to supplementary 1,
wherein the processor is configured to
perform, when generating the prompt sentence, feature extraction, rule matching, and
classification processing on the preprocessed character information using an information processing method, summarize or divide the character information and embed the summarized or divided character information into the prompt sentence, and instruct the generative AI model to output the numerical risk index and explanation information in a structured response format.

### Supplementary 3

The system according to supplementary 1,
wherein the processor is configured to
repeatedly execute evaluation processing by the generative AI model on the preprocessed character information that is sequentially transmitted from the terminal while a communication is in progress, update the numerical risk index over time, and generate the control signal at a time when the numerical risk index exceeds the predetermined threshold, thereby protecting the user from the fraudulent activity in real time.

### Application Example 1

### Supplementary 1

A system comprising a processor,
wherein the processor is configured to
acquire audio information and character information, convert the audio information into character information by using a speech recognition technique, and integrate the character information and the converted character information to generate analysis target information for each communication unit,
perform, on the analysis target information, semantic analysis processing and feature extraction processing by using a natural language processing technique and a machine learning technique to generate indicator information including terms, expressions, monetary requests, and expressions indicating persons in positions of authority that are related to fraudulent activity, and generate evaluation feature values regarding a possibility of fraudulent activity on the basis of the indicator information and the analysis target information,
execute evaluation processing to determine the possibility of fraudulent activity on the basis of the evaluation feature values, generate evaluation input information including a determination result and the indicator information, and generate a prompt sentence for input to a generative AI model on the basis of the evaluation input information,
input the prompt sentence to the generative AI model, acquire a generated result output from the generative AI model, the generated result including the possibility of fraudulent activity and grounds for the possibility, and determine operation control information including at least one of presentation of warning information in accordance with the possibility of fraudulent activity, storage of communication record information, and transmission of notification information to a pre-registered contact, on the basis of the determination result and the generated result, and
control an information output mechanism and a storage mechanism in accordance with the operation control information, and execute at least one of outputting a warning to a user, storing record information regarding communication content, and transmitting a warning notification to an external device.

### Supplementary 2

The system according to supplementary 1,
wherein the processor is configured to
generate the evaluation feature values by performing, on the analysis target information, feature value generation processing based on occurrence frequency of character strings, attribute feature value generation processing based on an event type and a communication medium type, and pattern identification processing of fraudulent activity patterns by using a pattern recognition technique or a machine learning algorithm, and to dynamically determine content of the prompt sentence for input to the generative AI model on the basis of the evaluation feature values.

### Supplementary 3

The system according to supplementary 1,
wherein the processor is configured to
perform threshold determination processing on the basis of a numerical evaluation value of the possibility of fraudulent activity derived from the evaluation feature values and the possibility of fraudulent activity and explanatory information regarding the possibility output from the generative AI model, and switch, in real time, a warning level and a type of operation to be executed so as to protect the user from fraudulent activity in accordance with a result of the threshold determination processing.

### Example 2

### Supplementary 1

A system comprising a processor,
wherein the processor is configured to
acquire audio information from a communication apparatus during a communication session,
convert the audio information into character information,
aggregate the character information in time series and manage the aggregated character information as character information for an entire communication session,
extract, from the character information for the entire communication session, character information corresponding to a predetermined time range and set the extracted character information as analysis target character information,
generate a prompt sentence including the analysis target character information and conditions for evaluating a possibility of unlawful activity,
input the prompt sentence into a generative information processing model and obtain an evaluation result indicating the possibility of unlawful activity with respect to the analysis target character information,
numerically convert the possibility of unlawful activity for the communication session based on the evaluation result, and, when a numerical value representing the possibility exceeds a threshold value, record the audio information and the character information of the communication session and generate summary information of the communication session,
generate alert notification information based on the evaluation result and the summary information and transmit the alert notification information to a pre-registered destination, and
transmit transmission status information of the alert notification information to a terminal and cause the terminal to display the transmission status information.

### Supplementary 2

The system according to supplementary 1,
wherein the processor is configured to
execute pattern recognition processing or machine learning processing on the character information for the entire communication session and on past communication history information, and dynamically generate the prompt sentence including evaluation conditions for the possibility of unlawful activity and an output format based on a result of the pattern recognition processing or the machine learning processing.

### Supplementary 3

The system according to supplementary 1,
wherein the processor is configured to
repeatedly input the prompt sentence to the generative information processing model and obtain the evaluation result at predetermined time intervals in accordance with progress of the communication session, and protect a user in real time from unlawful activity based on repeated execution of obtaining the evaluation result.

### Application Example 2

### Supplementary 1

A system comprising a processor,
wherein the processor is configured to
acquire communication information including audio information, convert the audio information included in the communication information into character information based on the communication information,
extract feature information indicating a possibility of fraudulent activity, based on the character information and emotion information associated with the character information,
generate a prompt sentence, for causing a generative information processing model to evaluate the possibility of the fraudulent activity, by using evaluation target information including the feature information,
input the prompt sentence into the generative information processing model and obtain an evaluation result regarding the possibility of the fraudulent activity from the generative information processing model, and
calculate an overall risk level of the fraudulent activity based on the evaluation result and the feature information, and control predetermined operations including at least one of recording processing, notification processing, and warning processing in accordance with the overall risk level.

### Supplementary 2

The system according to supplementary 1,
wherein the processor is configured to
execute information analysis processing including pattern recognition processing and machine learning processing on the character information, detect terms, expressions, and
action request patterns related to the fraudulent activity, and include the detected terms, expressions, and action request patterns in the evaluation target information.

### Supplementary 3

The system according to supplementary 1,
wherein the processor is configured to
obtain the emotion information by executing emotion estimation processing on at least one of the audio information and the character information included in the communication information, and calculate the overall risk level in real time by integrating the evaluation result obtained from the generative information processing model, an evaluation result obtained by the pattern recognition processing and the machine learning processing, and an evaluation result obtained by the emotion estimation processing.

What is claimed is:

1. A system comprising:
circuitry configured to:
receive, via a communication interface coupled to a packet-switched network, from a terminal device, audio data and character information associated with a communication session;
convert the audio data into converted character information using a speech recognition model;
generate, based on the converted character information and additional metadata associated with the communication session, a natural-language prompt sentence that instructs a generative neural network model to evaluate a possibility of anomalous activity;
execute the generative neural network model with the natural-language prompt sentence as an input to produce an evaluation result comprising a numerical risk index and explanation information; and
transmit, via the communication interface coupled to the packet-switched network, a control signal to the terminal device to cause execution of a predetermined control operation based on the evaluation result.

2. The system according to claim 1, wherein the circuitry is further configured to:
extract feature information from the converted character information using a natural language processing technique, the feature information comprising token frequency values, entity labels, and pattern indicators; and embed at least a portion of the feature information into the natural-language prompt sentence.

3. The system according to claim 2, wherein the circuitry is further configured to: apply a classification model to the feature information to generate a preliminary evaluation value representing a likelihood of the anomalous activity; and include the preliminary evaluation value in the natural-language prompt sentence as contextual input for the generative neural network model.

4. The system according to claim 3, wherein: the feature information comprises indicators of terms related to monetary requests, expressions indicating persons in positions of authority, and action request patterns associated with fraudulent activity; and the classification model comprises a decision tree ensemble model or a neural network classifier trained on labeled communication data.

5. The system according to claim 4, wherein the circuitry is further configured to: perform semantic analysis processing on the converted character information to detect named entities including monetary amounts, financial institution names, and personal identifiers; and encode detected named entities into the feature information as structured indicator values.

6. The system according to claim 1, wherein the circuitry is further configured to: aggregate the converted character information in time series to maintain character information for an entire communication session; and extract, from the character information for the entire communication session, a subset corresponding to a predetermined time range as analysis target character information used in generating the natural-language prompt sentence.

7. The system according to claim 6, wherein the circuitry is further configured to: repeatedly generate the natural-language prompt sentence and execute the generative neural network model at predetermined time intervals during the communication session to produce updated evaluation results; and update the numerical risk index over time based on the updated evaluation results.

8. The system according to claim 7, wherein: the predetermined time range defines a sliding window over the character information for the entire communication session; and the circuitry adjusts a length of the sliding window based on a detected speaking rate or topic boundary in the converted character information.

9. The system according to claim 8, wherein the circuitry is further configured to: detect that the numerical risk index exceeds a predetermined threshold during an ongoing communication session; and transmit the control signal to the terminal device in real time to cause display of warning information on the terminal device while the communication session is in progress.

10. The system according to claim 1, wherein the circuitry is further configured to: compare the numerical risk index with a plurality of threshold values to determine a risk level classification comprising one of a low risk level, a medium risk level, and a high risk level; and select the predetermined control operation from a plurality of available operations based on the risk level classification.

11. The system according to claim 10, wherein the plurality of available operations comprises: storing a communication record comprising at least one of the audio data and the converted character information in a storage device; transmitting notification information to a pre-registered contact associated with a user of the terminal device; and causing the terminal device to display warning information indicating the possibility of anomalous activity.

12. The system according to claim 11, wherein: the anomalous activity comprises fraudulent activity including at least one of impersonation of a person in a position of authority, coercive requests for financial information, and deceptive attempts to obtain authentication credentials; and the warning information comprises a text message generated based on the explanation information indicating specific risk factors identified in the communication session.

13. The system according to claim 1, wherein the circuitry is further configured to: apply an emotion estimation model to at least one of the audio data and the converted character information to generate emotion information representing a detected emotional state of a user of the terminal device; and incorporate the emotion information into the natural-language prompt sentence.

14. The system according to claim 13, wherein the circuitry is further configured to: calculate an overall risk level by integrating the evaluation result from the generative neural network model, feature information extracted from the converted character information, and the emotion information; and select the predetermined control operation based on the overall risk level.

15. The system according to claim 14, wherein: the emotion information comprises probability values for a plurality of emotion categories including fear and confusion; and the circuitry increases the overall risk level when the probability values for fear or confusion exceed respective emotion threshold values.

16. The system according to claim 1, wherein the circuitry is further configured to: generate summary information of the communication session by constructing a summarization prompt sentence and executing the generative neural network model with the summarization prompt sentence; and transmit alert notification information comprising the evaluation result and the summary information to a pre-registered destination.

17. The system according to claim 16, wherein: the alert notification information comprises a risk level indication, a summary of suspicious content identified in the communication session, and a recommended action for a recipient; the circuitry transmits transmission status information to the terminal device indicating whether the alert notification information was successfully delivered to the pre-registered destination; and the terminal device displays the transmission status information to the user.

18. A system comprising:
circuitry configured to:
receive, via a communication interface coupled to a packet-switched network, from a terminal device, audio data associated with a communication session;
convert the audio data into character information using a speech recognition model and aggregate the character information in time series;
extract, from the aggregated character information, analysis target character information corresponding to a predetermined time range;
generate a natural-language prompt sentence including the analysis target character information and conditions for evaluating a possibility of anomalous activity, the natural-language prompt sentence specifying an output format and evaluation criteria for a generative neural network model;
execute the generative neural network model with the natural-language prompt sentence as an input to produce an evaluation result comprising a risk assessment and explanation information; and
transmit, via the communication interface coupled to the packet-switched network, a control signal to the terminal device based on the evaluation result.

19. The system according to claim 18, wherein the circuitry is further configured to: numerically convert the risk assessment into a numerical risk index; compare the numerical risk index with a threshold value; and when the numerical risk index exceeds the threshold value, record the audio data and the character information and generate summary information of the communication session for transmission to a pre-registered destination.

20. A method performed by circuitry, the method comprising:
receiving, via a communication interface coupled to a packet-switched network, from a terminal device, audio data and character information associated with a communication session;
converting the audio data into converted character information using a speech recognition model;
generating, based on the converted character information and additional metadata associated with the communication session, a natural-language prompt sentence that instructs a generative neural network model to evaluate a possibility of anomalous activity;
executing the generative neural network model with the natural-language prompt sentence as an input to produce an evaluation result comprising a numerical risk index and explanation information; and
transmitting, via the communication interface coupled to the packet-switched network, a control signal to the terminal device to cause execution of a predetermined control operation based on the evaluation result.
